(19) United States
(12) Patent Application Publication
(10) Pub. No.: US 2016/0217399 A1
(43) Pub. Date: Jul. 28, 2016

(54) METHOD AND SYSTEM FOR MONITORING SHIPMENTS IN A SUPPLY AND/OR LOGISTICS CHAIN

(71) Applicant: ELEMENTUM SCM (CAYMAN) LTD., GRAND CAYMAN (KY)

(72) Inventors: FEKKO ROELOFS, Almere (NL); DANA BURROWS MARTIN, Sunnyvale, CA (US); MURUGESAN GURUSWAMY, San Jose, CA (US); BRITTANY MEDEROS, San Jose, CA (US)

(21) Appl. No.: 15/003,044

(22) Filed: Jan. 21, 2016

Related U.S. Application Data
(60) Provisional application No. 62/106,490, filed on Jan. 22, 2015.

(51) Int. Cl. G06Q 10/06; G06F 17/30; G06Q 50/28

(52) U.S. Cl. CPC G06Q 10/0635; G06Q 50/28; G06F 17/30327; G06F 17/30604

(57) ABSTRACT

A system and method for tracking shipments in a supply chain is provided. The method comprises: storing, in a computer-accessible memory, transport graph data structures that describe transport objects and relationships between transport objects in a supply chain, the transport graph data structures comprising nodes connected by branches, each node corresponding to a transport object of the transport objects in the supply chain and each branch associated with a type of relationship between two transport objects corresponding to two nodes connected by a respective branch; using a first computer, detecting, in a supply chain, a delay in shipment on a route segment transport object from an origin transport object to a destination transport object; using the first computer, identifying, from the transport graph data structures, nodes corresponding to the destination transport object, and the route segment transport object corresponding to the delay in shipment; using the first computer, identifying, from the transport graph data structures, an alternate transport object node positioned between nodes corresponding to a current or anticipated location of the shipment and the destination transport object; providing, via a user interface presented on a display screen of the first computer, a description of the delay and the alternate transport object node.

### BENEFIT CLAIM

This application claims the benefit under 35 U.S.C. §119(e) of provisional application 62/106,490, filed Jan. 22, 2015, the entire contents of which are hereby incorporated by reference for all purposes as if fully disclosed herein.

### FIELD

The disclosure relates generally to automated systems for analyzing the impact of an event on a network.

### BACKGROUND

The traditional structure of the business supply and/or logistics chain, which viewed supply and/or logistics chain management as a chain of events, is evolving, in response to the ever-complicated logistics of modem trade, commerce and communications, towards viewing supply and/or logistics chain management as a three-dimensional model. In other words, organizations no longer view supply networks as a linear relationship between raw materials and distributors. Rather, today's supply web resembles a three-dimensional construct, complete with a variety of suppliers, tiers and intermediaries that serve to fill in for one another in the event of a disruption.

Increasingly, how well a supply web creates and shares information not only defines how well the web holds together, how efficiently it operates, and how much value it adds but also determines the success or failure—as a group—of the manufacturing venture. Companies need to share supply metrics, timelines, demands and capacity data to enable the supply network to develop a common and aligned set of objectives, which can protect it against commodity pressures, volatility and individual failures. Sharing information can speed up supply and/or logistics chains while mitigating the inherent risks in doing so. This new model, with cost management at its core, can capture decades of best practices in a unified strategy for a new generation of companies and managers.

Although significant advances have been made towards establishing a three-dimensional supply chain by companies such as E2open™TM, GT Nexus™, and Resiline™, problems remain. Many three-dimensional supply and/or logistics chains are fairly rigid and unable to respond dynamically to, let alone anticipate, adverse events. This can cause disruption in the supply and/or logistics chain and concomitant interruptions in the product distribution chain. They also fail to provide users with the supply and/or logistics chain information necessary to mitigate the impact of events quickly, efficiently, and effectively.

### SUMMARY

These and other needs are addressed by the various aspects, embodiments, and/or configurations of the present disclosure. The present disclosure generally discloses a transport module that can monitor, evaluate, and/or improve performance of a selected transport object in a supply and/or logistics chain. The selected transport object can be, for example, one or more of a route segment, shipment, hub, source load facility, destination unload facility, and freight carrier.

A server can include: a microprocessor; a memory; a network interface to receive incoming and send outgoing messages; a buffer for temporary storage of incoming and send outgoing messages; and an interface driver to provide the control signals to effect operation of the network interface and buffer.

The memory can include a microprocessor executable transport object performance analyzer operable to analyze a performance of a selected transport object in a respective supply and/or logistics chain relative to predetermined rules, objectives, policies and/or performance thresholds to determine if the selected transport object is performing acceptably and, when the selected transport object is not performing acceptably, operable to provide, via the network interface, buffer, and interface driver and to a user, an indication that the selected transport object is not performing acceptably.

The transport object performance analyzer can determine, for a transport object not performing acceptably, a significance of an impact of the selected transport object on a selected object in the respective supply and/or logistics chain.

When the transport object is a shipment, a shipment tracking module can track a spatial location of the shipment in substantial real time, by a real-time locating system, using one or more of satellite position information and terrestrial antenna information.

The shipment tracking module can provide an estimated arrival time of the shipment at a selected destination using one or more of a current location of the shipment, a speed of movement of the shipment, a time required by one or more other shipments in temporal proximity to a current time to traverse one or more transport objects between the current spatial location of the shipment and the selected destination, and a level of performance of the one or more transport objects between the current spatial location of the shipment and the selected destination.

When the selected transport object is a hub, the transport object performance analyzer can determine that the hub is performing acceptably when at least a specified number or percentage of the shipments received by the hub within a first specified period exit the hub within a second specified period.

When the selected transport object is a route segment, the transport object performance analyzer can determine that the route segment is performing acceptably when at least a specified number or percentage of the shipments passing over the route segment within a third specified period exit the route segment within a fourth specified period.

When the selected transport object is a destination facility, the transport object performance analyzer can determine that the destination facility is performing acceptably when at least a specified number or percentage of shipments received by the destination facility within a fifth specified period have an inter-notification time period falling within a selected time interval.

In other configurations, the transport object performance analyzer can determine that the performance of the selected transport object is acceptable when an average, mean, median, or mode performance parameter measured over a selected time interval for the selected transport object satisfies an acceptable performance threshold.

In other configurations, the transport object performance analyzer can determine that the performance of the selected transport object is acceptable when at least a threshold percentage of shipments pass through the selected transport object within a standard deviation of a target time.

The transport object performance analyzer can maintain a performance history of each selected transport object for a selected monitoring time period to grade or rate a performance of the selected transport object relative to other transport objects.

A server can have, in memory, a microprocessor executable transport resource manager that, for an unacceptably performing transport object, (a) determines degree of impact of the underperformance on a respective supply and/or logistics chain containing or using the unacceptably performing transport object and/or (b) identifies and/or recommends one or more alternative transport objects to mitigate the effect of the underperformance on the respective supply and/or logistics chain.

A server can have, in memory, a set of transport graph data structures comprising nodes interconnected by branches, each node corresponding to a transport object in or used by a respective supply and/or logistics chain and each branch describing a type of relationship between nodes interconnected by the respective branch.

A computer display can include: a light source; a polarized substrate comprising a liquid crystal material positioned between at least first and second polarized glass layers; an electrical current source to provide electrical currents to cause the liquid crystal material to align to allow a selected level of light to pass through at least part of the substrate and provide a displayed image; and a display selector to control the light and electrical current sources to produce the displayed image, wherein the displayed image contains a plurality of tiles, each tile corresponding to a shipment in a supply and/or logistics chain, wherein one or more of an appearance, shape, location, and size of each tile indicates a significance of an impact of the shipment on one or more of a site, part, component, product, enterprise of the supply and/or logistics chain.

The display can be updated as the impact of a shipment is mitigated by a recalculation of the impact significance on each site, part, component, product, or enterprise. When the impact of the shipment on the corresponding site, part, component, product, and enterprise is resolved, for example, the display can be updated by removing the resolved tile from the display and recalculating a relative significance of the impact assigned to the remaining tiles.

By interacting with a tile, a user can receive additional information on the corresponding shipment. The additional information can include one or more of an emergency contact for the person corresponding to the carrier handling the shipment, a comment area for entering comments regarding the corresponding shipment, and an update button, the update button allowing the user to add one or more additional tags representing any new information or status.

This disclosure is intended to encompass the method of operation and tangible and non-transient computer readable medium containing microprocessor executable instructions to perform the operations of each of the communication device, server, and system.

The present disclosure can provide a number of advantages depending on the particular aspect, embodiment, and/or configuration. The supply and/or logistics chain management system can, particularly for vertically integrated supply and/or logistics chains, more effectively and efficiently control suppliers, prices, product supply, and other terms, generate faster material turns or velocities, increase profit, enable leaner manufacturing and logistics operations, and reduce waste when compared to a supply and/or logistics chain without the supply and/or logistics chain management system. It can more effectively consider the impact of unanticipated or “black swan” events, including natural and manmade disasters, by monitoring news sources, law enforcement and military authorities, among others, and precisely map tier 1, 2, 3, and 4 facilities. It can effectively assess the sensitivity of the supply and/or logistics chain to various internal and external events. It can assess the risk of having a particular product or product component available at a selected location at a selected price or cost. It can enable greater levels of collaboration not only among the various tiers but also within tiers of the supply and/or logistics chain. It can enable more effective management of multiple sources, within a given tier, even for legally distinct, competitive entities. Ranking the items, impacted by an event, against one another enables the user to know which is a more significant impact to the corresponding supply and/or logistics chain. The “relative” aspect takes this algorithm from a generic risk analysis to a risk analysis configured for a selected set of circumstances. The system's combination of cloud tools, operating models, and risk management logic can create new, more profitable and effective business practices in three-dimensional supply and/or logistics chains. The transport module can use multiple sources of shipment-related information (and not just information provided by the responsible carrier), thereby providing customers with more accurate shipment arrival estimates and shipment tracking information than is currently provided by carriers and can combine shipment times for various route segments and different carriers, thereby providing one arrival estimate to customers.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

“Automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

“Computer-readable medium” as used herein refers to any tangible and non-transient storage and/or transmission medium that participate in providing instructions to a processor for execution. Such a medium may take many forms, including but not limited to, non-volatile media, volatile media, and transmission media and includes without limitation random access memory (“RAM”), read only memory (“ROM”), and the like. Non-volatile media includes, for example, NVRAM, or magnetic or optical disks. Volatile media includes dynamic memory, such as main memory. Common forms of computer-readable media include, for example, a floppy disk (including without limitation a Bernoulli cartridge, ZIP drive, and JAZ drive), a flexible disk, hard disk, magnetic tape or cassettes, or any other magnetic medium, magneto-optical medium, a digital video disk (such as CD-ROM), any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art recognized equivalents and successor media, in which the software implementations of the present disclosure are stored. Computer-readable storage medium excludes transient storage media, particularly electrical, magnetic, electromagnetic, optical, magneto-optical signals.

A “database” is an organized collection of data held in a computer. The data is typically organized to model relevant aspects of reality (for example, the availability of specific types of inventory), in a way that supports processes requiring this information (for example, finding a specified type of inventory). The organization schema or model for the data can, for example, be hierarchical, network, relational, entity-relationship, object, document, XML, entity-attribute-value model, star schema, object-relational, associative, multidimensional, multi value, semantic, and other database designs. Database types include, for example, active, cloud, data warehouse, deductive, distributed, document-oriented, embedded, end-user, federated, graph, hypertext, hypermedia, in-memory, knowledge base, mobile, operational, parallel, probabilistic, real-time, spatial, temporal, terminology-oriented, and unstructured databases.

“Database management systems” (DBMSs) are specially designed applications that interact with the user, other applications, and the database itself to capture and analyze data. A general-purpose database management system (DBMS) is a software system designed to allow the definition, creation, querying, update, and administration of databases. Well-known DBMSs include MySQL™, PostgreSQL™, SQLite™, Microsoft SQL Server™, Microsoft Access™, Oracle™, SAP™, dBASE™, FoxPro™, and IBM DB2™. A database is not generally portable across different DBMS, but different DBMSs can inter-operate by using standards such as SQL and ODBC or JDBC to allow a single application to work with more than one database.

“Determine”, “calculate” and “compute,” and variations thereof, as used herein, are used interchangeably and include any type of methodology, process, mathematical operation or technique.

A “Display” refers to a computer output providing one or more computer generated image(s) to a user. The output is typically a liquid crystal display (“LCD”) or cathode ray tube (“CRT”). Liquid crystal display technology works by blocking light. Specifically, an LCD is made of two pieces of polarized glass (also called substrate) that contain a liquid crystal material between them. A backlight creates light that passes through the first substrate. At the same time, electrical currents cause the liquid crystal molecules to align to allow varying levels of light to pass through to the second substrate and create colors and images for the outputted image. Most LCD displays use active matrix technology. A thin film transistor (TFT) arranges tiny transistors and capacitors in a matrix on the glass of the display. To address a particular pixel, the proper row is switched on, and then a charge is sent down the correct column. Since all of the other rows that the column intersects are turned off, only the capacitor at the designated pixel receives a charge. The capacitor is able to hold the charge until the next refresh cycle. The other type of LCD technology is passive matrix. This type of LCD display uses a grid of conductive metal to charge each pixel. A CRT monitor contains million S of tiny red, green, and blue phosphor dots that glow when struck by an electron beam that travels across the screen to create a visible image. In a cathode ray tube, the “cathode” is a heated filament. The heated filament is in a vacuum created inside a glass “tube.” The “ray” is a stream of electrons generated by an electron gun that naturally pour off a heated cathode into the vacuum. Electrons are negative. The anode is positive, so it attracts the electrons pouring off the cathode. This screen is coated with phosphor, an organic material that glows when struck by the electron beam. Filtration of the electron beam to produce the outputted image can be done by one or more of shadow marks, aperture grill, and slot mask.

An “Electronic Product Code” (EPC) is designed as a universal identifier that provides a unique identity for every physical object anywhere in the world, for all time. Its structure is defined in the EPCglobal Tag Data Standard, which is an open standard freely available for download from the website EPCglobal, Inc. The canonical representation of an EPC is a URI, namely the “pure-identity URI” representation that is intended for use when referring to a specific physical object in communications about EPCs among information systems and business application software. The EPCglobal Tag Data Standard also defines additional representations of an EPC identifier, such as the tag-encoding URI format and a compact binary format suitable for storing an EPC identifier efficiently within RFID tags (for which the low-cost passive RFID tags typically have limited memory capacity available for the EPC/UII memory bank). The EPCglobal Tag Data Standard defines the structure of the URI syntax and binary format, as well as the encoding and decoding rules to allow conversion between these representations. The EPC is designed as a flexible framework that can support many existing coding schemes, including many coding schemes currently in use with barcode technology. EPCs are not designed exclusively for use with RFID data carriers. They can be constructed based on reading of optical data carriers, such as linear bar codes and two-dimensional bar codes, such as Data Matrix symbols.

An “enterprise” refers to a business and/or governmental organization, such as a corporation, partnership, joint venture, agency, military branch, company, and the like

“Enterprise resource planning” or ERP systems integrate internal and external management information across an entire organization, embracing finance/accounting, manufacturing, sales and service, customer relationship management, and the like. ERP systems automate this activity with an integrated software application. The purpose of ERP is to facilitate the flow of information between all business functions inside the boundaries of the organization and manage the connections to outside stakeholders.

A “logistics hub” is a center, facility, or installation for shipment, storage, collection and/or distribution of goods, such as products, parts, components, and/or raw materials.

“Means” as used herein shall be given its broadest possible interpretation in accordance with 35 U.S.C., Section 112(f). Accordingly, a claim incorporating the term “means” shall cover all structures, materials, or acts set forth herein, and all of the equivalents thereof. Further, the structures, materials or acts and the equivalents thereof shall include all those described in the summary of the invention, brief description of the drawings, detailed description, abstract, and claims themselves.

“Module” as used herein refers to any known or later developed hardware, software, firmware, artificial intelligence, fuzzy logic, or combination of hardware and software that is capable of performing the functionality associated with that element. Also, while the disclosure is presented in terms of example embodiments, it should be appreciated that individual aspects of the disclosure can be separately claimed.

An “original equipment manufacturer”, or OEM, manufactures product or components that it sells to end users or another enterprise and retailed to end users under that purchasing enterprise's brand name. OEM generally refers to an enterprise that originally manufactured the final product for a purchaser, such as a consumer. For example, Ford™ and General Motors™ are OEM companies that manufacture cars, and Apple™ is a computer OEM. The brand owner may or may not be the OEM.

A “performance indicator” or “key performance indicator” (“KPI”) is a type of performance measurement. An organization may use KPIs to evaluate its success, or to evaluate the success of a particular activity in which it is engaged.

“Real-time locating systems” or RTLS are used to automatically identify and track the location of objects or people in real time, usually within a building or other contained area. Wireless RTLS tags are attached to objects or worn by people, and in most RTLS, fixed reference points receive wireless signals from tags to determine their location. Examples of real-time locating systems include tracking automobiles through an assembly line, locating pallets of merchandise in a warehouse, or finding medical equipment in a hospital. The physical layer of RTLS technology is usually some form of radio frequency (RF) communication, but some systems use optical (usually infrared) or acoustic (usually ultrasound) technology instead of or in addition to RF. Tags and fixed reference points can be transmitters, receivers, or both, resulting in numerous possible technology combinations. RF trilateration can use estimated ranges from multiple receivers to estimate the location of a tag. RF triangulation uses the angles at which the RF signals arrive at multiple receivers to estimate the location of a tag.

A “server” is a computational system (for example, having both software and suitable computer hardware) to respond to requests across a computer network to provide, or assist in providing, a network service. Servers can be run on a dedicated computer, which is also often referred to as “the server”, but many networked computers are capable of hosting servers. In many cases, a computer can provide several services and have several servers running. Servers typically include a network interface to receive incoming and send outgoing messages, a buffer for temporary storage of incoming and send outgoing messages, and an interface driver to provide the control signals to effect operation of the network interface and buffer.

A “supply and/or logistics chain” refers typically to a tiered supply chain. The chain commonly links business functions and processes in the chain into an integrated business model. Each enterprise in a tier supplies an enterprise in the next highest tier and is in turn supplied by an enterprise in the next lowest tier. For example, a tier two company supplies a tier one company, a tier three company supplies a tier two company, and so on.

A “tier one enterprise” supplies parts or components directly to an original equipment manufacturer (“OEM”), which typically sets up the supply and/or logistics chain. A tier one enterprise commonly has the skills and resources to supply the parts or components that an OEM needs, including having established processes for managing suppliers in the tiers below them. In some applications, tier one enterprises provide a manufacturing service for the OEM, leaving the OEM to concentrate on final product assembly and/or marketing.

A “tier two enterprise” is a supplier to a tier one enterprise and generally do not supply parts or components directly to the OEM. A single enterprise, however, may be a tier one enterprise supplier to one company and a tier two enterprise supplier to another company or may be a tier one enterprise supplier for one product and a tier two enterprise supplier for a different product line. Similar rules apply for enterprises in other tiers, such as tier three enterprises, tier four enterprises, and so on. For example, tier three enterprise suppliers supply directly to tier two enterprises and tier four enterprise suppliers supply directly to tier three enterprises. In many supply and/or logistic chains, tier four enterprise suppliers are providers of basic raw materials, such as steel and glass, to higher-tier enterprise suppliers.

A “warehouse management system” (WMS) is a part of the supply and/or logistics chain and controls the movement and storage of materials or inventory within a warehouse and processes the associated transactions, including shipping, receiving, putaway and picking. The systems can also direct and optimize stock putaway based on real-time information about the status of bin utilization. A WMS monitors the progress of products through the warehouse. It involves the physical warehouse infrastructure, tracking systems, and communication between product stations. Commonly, warehouse management involves the receipt, storage and movement of goods, (normally finished goods), to intermediate storage locations or to a final customer. In the multi-echelon model for distribution, there may be multiple levels of warehouses. This includes a central warehouse, a regional warehouses (serviced by the central warehouse) and potentially retail warehouses (serviced by the regional warehouses). Warehouse management systems often utilize automatic identification and data capture technology, such as barcode scanners, mobile computers, wireless LANs and potentially radio-frequency identification (RFID), to efficiently monitor the flow of products. Once data has been collected, there is either a batch synchronization with, or a real-time wireless transmission to a central database. The database can then provide useful reports about the status of goods in the warehouse.

The preceding is a simplified summary of the disclosure to provide an understanding of some aspects of the disclosure. This summary is neither an extensive nor exhaustive overview of the disclosure and its various aspects, embodiments, and/or configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and/or configurations of the disclosure are possible utilizing, alone or in combination, one or more of the features set forth above or described in detail below.

### BRIEF DESCRIPTION OF THE DRAWINGS

The accompanying drawings are incorporated into and form a part of the specification to illustrate several examples of the present disclosure. These drawings, together with the description, explain the principles of the disclosure. The drawings simply illustrate preferred and alternative examples of how the disclosure can be made and used and are not to be construed as limiting the disclosure to only the illustrated and described examples. Further features and advantages will become apparent from the following, more detailed, description of the various aspects, embodiments, and configurations of the disclosure, as illustrated by the drawings referenced below.

FIG. 1 is a block diagram of an example three-dimensional supply and/or logistics chain;

FIG. 2 depicts a communications networked architecture according to an embodiment;

FIG. 3 depicts an example of a supply and/or logistics chain monitoring system;

FIG. 4 depicts a globally distributed supply and/or logistics chain display according to an embodiment;

FIG. 5 is a block diagram of an example transport module;

FIG. 6 is a screen shot according to an embodiment;

FIG. 7 is a screen shot according to an embodiment;

FIG. 8 is a screen shot according to an embodiment;

FIG. 9 is a screen shot according to an embodiment;

FIG. 10 is a screen shot according to an embodiment;

FIG. 11 is a flow chart of an example shipment tracking module;

FIG. 12 is a flow chart of an example transport object performance analyzer; and

FIG. 13 is a flow chart of an example transport resource manager.

### DETAILED DESCRIPTION

The Supply and/or Logistics Chain Management System

The supply and/or logistics chain management system 150 will be discussed with reference to FIG, 1, which illustrates a simplified supply and/or logistics chain and is not intended to be limiting for purposes of this disclosure. Generally, parts and components of products are made from materials and/or other parts and components, and finished goods or products are made from materials, parts, and/or components. Materials are generally considered to be raw materials, or crude or processed materials or substances.

A tier 1 enterprise 100, in a brand level, typically corresponds to an OEM that is also a brand owner, such as a retail and/or wholesale vendor, supplier, distributor, or other business that provides its branded products to end users. These businesses typically invest in research and development, product design, marketing, and brand development. Examples include Ford™, General Motors™, Toyota™, Apple™, Amazon™, Cisco Systems, Inc.™, and Microsoft Corporation™. The tier 1 enterprise 100 monitors (and collects information regarding) the supply and/or logistics chain, product inventory levels, product demand, and/or prices of competitive products and, based on the collected information and product demand and price projections, dictates to second tier enterprise partners, prices, supply requirements, and other material terms, and accesses performance information of such second and third tier enterprise partners to monitor supply and/or logistics chain performance.

A tier 2 enterprise supplier 104, in an integration level, assembles parts and/or components received from tier 3 enterprise suppliers 108a-n into products, which are shipped, by the tier 2 enterprise supplier 104, to the tier 1 enterprise 100 for manufacture and sale of finished goods or products. As will be appreciated, the tier 1 enterprise 100 can be an OEM. Tier 2 enterprise supplier(s) 104 provide, to the supply and/or logistics chain management system 150, its respective supply and/or logistics chain performance information and/or supply and/or logistics chain performance information received from tier 3 part and/or component enterprise suppliers.

The first, second, . . . nth tier 3 enterprise suppliers 108a-n, at the device level, manufacture parts and/or components for assembly by the tier 2 enterprise supplier 104 into products. The first, second, . . . nth tier 3 part and/or enterprise suppliers 108a-n provide, to the supply and/or logistics chain management system 150 or to the tier 2 enterprise supplier 104 for provision to the supply and/or logistics chain management system 150, its supply and/or logistics chain respective performance information and supply and/or logistics chain performance information received from tier 4 enterprise suppliers 112a-m.

The first, second, third, . . . mth tier 4 enterprise suppliers 112a-m, at the raw material level, manufacture and supply to the first, second, . . . nth tier 3 enterprise suppliers 108a-n materials for use in manufacturing parts and components for supply to the tier 2 enterprise supplier. The first, second, third, . . . mth tier 4 material suppliers 112a-m provide, to the supply and/or logistics chain management system 150 or to the tier 3 enterprise suppliers for provision to the supply and/or logistics chain management system 150, its respective supply and/or logistics chain performance information.

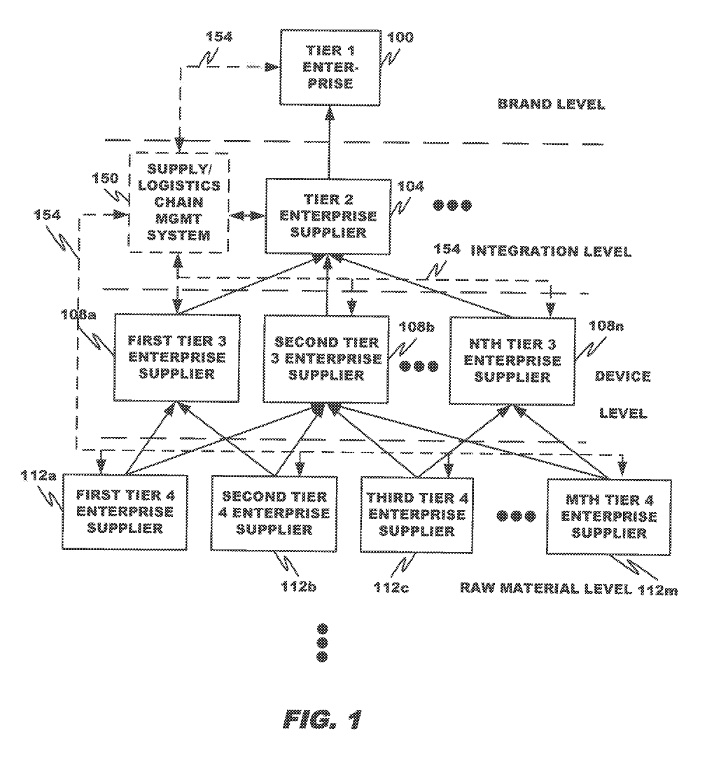

As shown by the ellipses at the bottom of FIG. 1, additional tiers of enterprise suppliers can exist depending on the application and industry.

The brand, integration, device and raw material levels are for purposes of illustration only and are not necessarily associated with the depicted tier. For example, the brand level mayor may not be associated with the tier 1 enterprise(s) 100; the integration level mayor may not be associated with the tier 2 enterprise supplier(s) 104; the device level mayor may not be associated with the tier 3 enterprise supplier(s) 108a-n; and the raw material level may or may not be associated with the tier 4 enterprise supplier(s) 112a-m.

Each of the tier 1 enterprise 100, tier 2 enterprise supplier 104, first, second, third, . . . nth tier 3 enterprise suppliers 108a-n, and first, second, third, . . . mth tier 4 enterprise suppliers 112a-m correspond to an enterprise, which may or may not be related to or affiliated with another enterprise in the supply and/or logistics chain of FIG. 1.

As shown by the arrows, air, land, and sea logistics providers link the various tier partners with an integrated network of air, sea, and ground capabilities to enable effective movement of materials, components, and products from sources (or points of origination) to destinations.

As will be appreciated, each tier 1, 2, 3 and 4 enterprise can have one or more sites where a supply and/or logistics chain activity occurs. The sites can, for example, be a manufacturing, processing, or treatment facility such as a factory or plant, storage facility such as a warehouse, distribution facility, mine, farm, ranch, or other agricultural facility, and the like. The various sites can be co-located or distributed depending on the application.

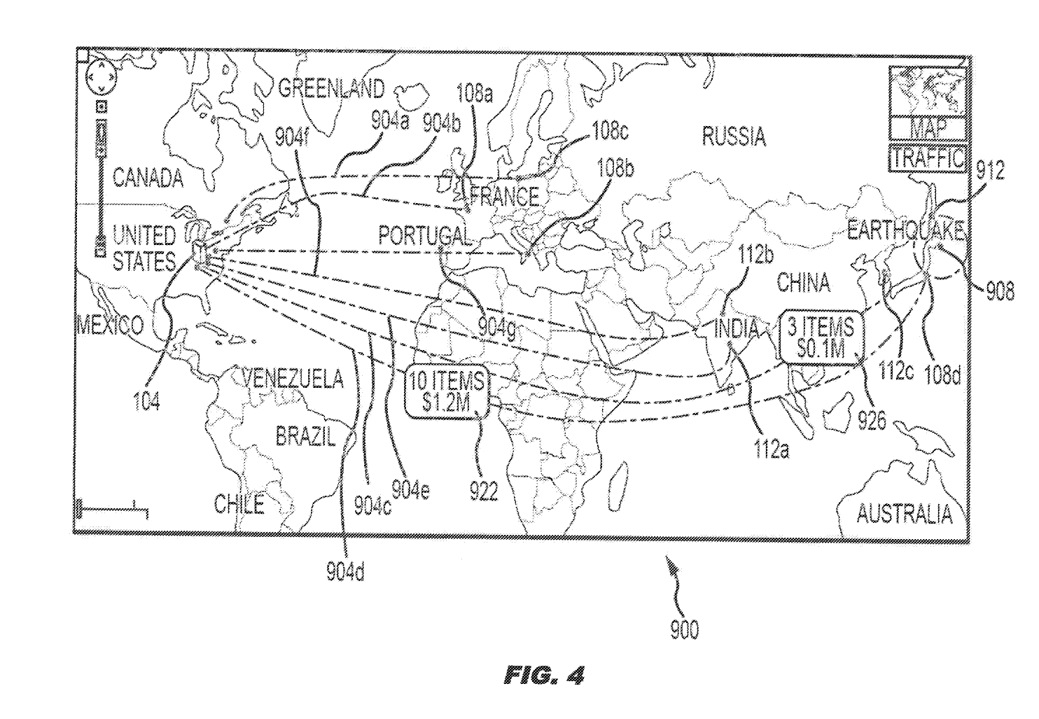

FIG. 4 (which can be a display outputted by the supply and/or logistics chain management system 150) is an illustration of a globally distributed supply and/or logistics chain 200. With reference to FIG. 4, locations of various supply and/or logistics chain sites, including the tier 2 enterprise supplier 104, first, second, . . . nth tier 3 enterprise suppliers 108a-n, and first, second, third, . . . mth tier 4 enterprise suppliers 112a-m. Material and/or part and/or component and/or product shipment lines 200a-g between the various related nodes can be shown. Different colors or shades of a common color or line patterns or shading can be assigned to each shipment line to indicate on-time shipments, slightly delayed shipments, moderately delayed shipments, and heavily delayed shipments. Moving a cursor over a node, shipment line, or event can cause a box or icon, such as shown by boxes 422 and 426, to appear providing relevant information about the associated one of the node, shipment line, or event. For example, relevant information about the node can include enterprise and/or organization name, materials and/or part and/or component and/or products supplied by the enterprise, and one-hop related enterprises (for example, the supplier to the selected node and the purchaser from the selected node). Relevant information about the shipment line can include the name of the freight carrier, number, type, and value of material and/or part and/or component and/or product currently being shipped, and the current status of the shipment. The boxes in FIG. 4 show relevant shipment information including a number and value of products, parts, and/or components currently en route along the corresponding shipment line.

With respect to FIG. 1, the supply and/or logistics chain management system 150, via communication links 154, monitors (and collects information regarding) first, second, third, fourth, . . . tier enterprises in the supply and/or logistics chain to determine supply and/or logistic chain performance information. Example users of the system 150 include brand owners (for example, retailers and wholesalers), and/or contract manufacturer and OEM representatives, such as a manufacturing representative, enterprise officers, and managers. Due to the adverse impact on the performance of the supply and/or logistics chain, the supply and/or logistics chain management system 150 can monitor for events potentially impacting adversely, or disrupting, supply and/or logistics chain performance.

“Supply and/or logistics chain performance information” typically includes any information relative to supply and/or logistics chain configuration and/or performance, including, without limitation, one or more of manufactured item output projections over a specified time period, production facility sizes and/or locations, raw material, work-in-process, and/or manufactured part, component, and/or product inventory levels, outstanding orders, order cycle times, days of supply in inventory, manufacturing resource type, availability, reliability, and/or productivity (for example, human and automated resource levels and resulting output levels), unit operations (for example, manufacturing steps, functions, or operations, unloading raw materials, packaging parts, components, and/or products, loading parts, components, and/or products, and the like), financial factors (or example, labor rates and costs, energy rates and costs, raw materials costs, freight costs, tax rates, administrative and overhead costs, contractual and/or current spot market part, component, and/or product prices (from lower tier components), and the like), number of on time shipments, number of late shipments, order mismatch count, service quality (for example, repair returns, repeat repair, no fault found, etc.), repair cost per unit (for example, material cost per unit, average repair time, pieces consumed per unit, etc.), inventory value (for example, spare parts stock, or SWAP stock, inventory turnover, days of supply of spare parts, days of supply of SWAP, days sales inventory spare parts, excess spare parts, excess SWAP stock, return to vendor rate, defective or ORB, and return to vendor or TAT, etc.), historic, current, and/or projected compliance with price, supply requirements, and/or other material terms, historic, current, and/or projected parts, components, and/or product output levels, mean, median and/or average, mode, historic, and/or projected freight transportation times, delays, or requirements, and the like. The performance information can be associated with a date, month, and/or season-of-year. KPI metrics can be generated from the performance information, such as on time shipment rate or percentage, late shipment rate or percentage, product rejection rate based on nonconformance with one or more restrictions, specifications, and/or requirements, parts, components, and/or product acceptance rate based on conformance with one or more restrictions, specifications, and/or requirements, and the like.

While the above example assumes that supply and/or logistics chain performance information is supplied to the nearest downstream partner, it is possible that one or more of the tier 2, 3, and 4 partners and/or logistic providers provide supply and/or logistics chain performance information directly to the supply and/or logistics chain management system 150. It is further to be understood that any number of entities, factories, plants, or other facilities may exist at each of the brand, integration, device, and raw material levels

Inventory, whether a product or part or component of the product, can be tracked by the supply and/or logistics chain management system 150 manually or automatically or a combination thereof. A manual system, for example, is a system known as the card system or cardex. Other manual systems use a type of manual entry system to record inventory transactions and record the entries in a spreadsheet program rather than on a paper card. In automated systems, whenever a movement of inventory occurs, an inventory management system receives an automatic update of the transaction. Various tracking methods exist to track inventory. The barcode, also known as the Universal Product Code (UPC), remains one of the most common inventory tracking methods. Barcodes can track the movement of inventory throughout the supply and/or logistics chain. The barcode contains data on the item's description, the item's price and the item's unit of measure. Radio frequency identification (RFID) is another method used to track inventory. RFID technology comes in two forms: active RFID and passive RFID. Active RFID works best in environments where security issues exist and ones that require real-time tracking information. Passive RFID works best when used with handheld scanners and where security issues do not exist. Electronic Product Codes may also be employed. Code or identifier sensors or readers are positioned throughout the supply and/or logistics chain, typically at entrance and exit points to a facility, such as a warehouse, to detect inventory movement and identify what inventory items have moved. The readers at each ingress or egress (or choke) point can be meshed auto-ID or hand-held ID applications. Tracking can also be capable of providing monitoring data without binding to fixed location by using a cooperative tracking capability, for example a real-time locating system or RTLS. In this way, the inventory tracking system can track the addition of items to an inventory and any disbursements from inventory.

The detected codes or identifiers can be fed into Work in Progress models (WIP) or Warehouse Management Systems (WMS) or ERP software. These models or modules can then provide the inventory information to the other supply and/or logistics chain members, such as the supply and/or logistics chain management system 150.

There are a number of examples of events impacting the performance of a selected supply and/or logistics chain. Events can include, for example, natural disasters (for example, natural disaster event and wherein the natural disaster is one or more of an earthquake, tsunami, volcanic eruption, fire, flood, avalanche, and landslide), weather patterns (for example, storm, typhoon, hurricane, cyclone, tornado, wind, flood, and blizzard), political disruptions (for example, coup d'etat, revolutions, changes or upheavals, sabotage, terrorism, act of war, military action, police action, embargo, and blockade), criminal actions (for example, piracy, hijacking, theft, arson, vandalism, and the like), acts of violence (for example, terrorism, war, political upheaval, military action, and the like), freight disruptions (for example, train derailment, maritime vessel sinking, airplane crash, freight embargo, freight vehicle wreck, naval blockades and the like), energy shortages, disruptions, or blackouts, business disruptions (for example, device or system malfunction, labor disruption (for example, strikes or threatened strikes), lawsuit, financial insolvency, public announcement by a partner or competitor, scheduled event or holiday (for example, religious, political, or other holidays), and bankruptcy), and/or a human and/or animal health event, such as a health emergency, sickness, death, species endangerment, and/or species extinction caused by one or more of a pathogen, disease, virus, nano-virus, biological weapon, bacteria, parasite, worm, fungus, prion, and/or any other animal health-related outbreak, epidemic, pandemic, etc., and/or any other event that is external or internal to the supply and/or logistics chain (for example production quality issue, inventory stock shortage, manufacture system, device, or apparatus malfunction, or other event that demands or causes lead time within the supply and/or logistics chain).

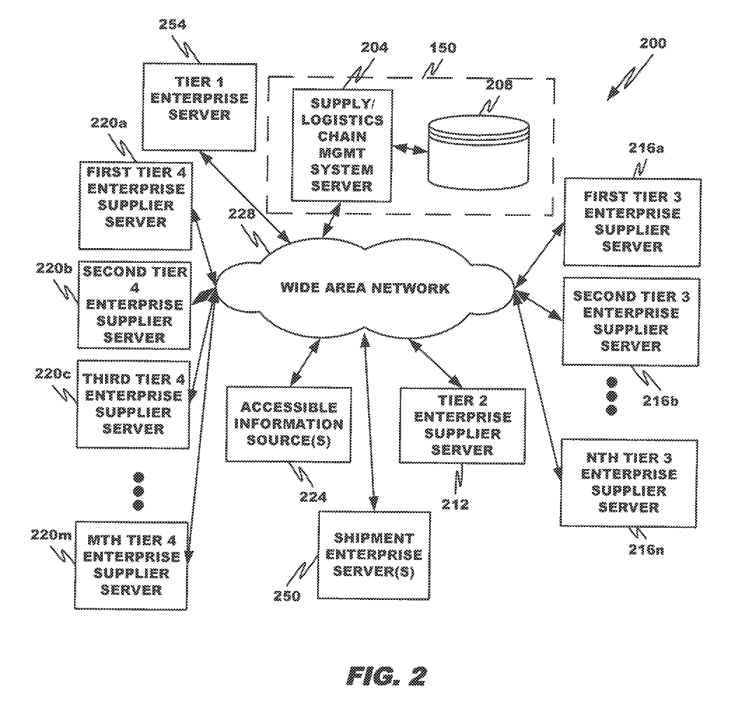

FIG. 2 depicts a communications networked architecture 200 according to an embodiment.

The supply and/or logistics chain management system 150 comprises a server 204 and associated database management system (not shown) and database 208. As will be appreciated, the supply and/or logistics chain management system 150 can be maintained by anyone of the tier 1, 2, 3, and/or 4 enterprises or an entity independent of the foregoing.

The supply and/or logistics chain management server 204 can be any computerized process that shares a resource with one or more client processes. 1t may run one or more services (typically as a host), to service the needs of other computers on the network. Typically, the supply and/or logistics chain management server 204 is a computer program running to serve the requests of other programs.

The database 208 can be any organized collection of data and their supporting data structures. The database can be based on any data model, including the relational model, entity-relationship model, object model, object relational model, XML, or other database model.

Referring again to FIG. 2, the tier 1 enterprise 100 can have a corresponding tier 1 enterprise supplier server 254 to provide supply and/or logistics chain performance and other information, directly or indirectly, to the supply and/or logistics chain management server 204.

The tier 2 enterprise supplier 104 can have a corresponding enterprise supplier server 212 to provide supply and/or logistics chain performance and other information, directly or indirectly, to the supply and/or logistics chain management server 204.

Each of the first, second, . . . nth tier 3 enterprise suppliers 108a-n can have a corresponding tier 3 enterprise supplier server 216a-n to provide supply and/or logistics chain management performance and other information, directly or indirectly, to the supply and/or logistics chain management server 204.

Each of the first, second, third, . . . mth tier 4 enterprise suppliers 112a-m can have a corresponding tier 4 enterprise supplier server 220a-m to provide supply and/or logistics chain management performance and other information, directly or indirectly, to the supply and/or logistics chain management server 204.

The shipment enterprise server(s) 250 represent(s) the freight enterprises or carriers handling air, land or water borne shipments between nodes (for example, sites) of the supply and/or logistics chain. The freight enterprises can be any entity providing shipping or freight services. Example freight enterprises include railway companies, short and long haul trucking companies, freight company servers (to provide freight tracking information, freight movement projections between two locations, and the like), shipping lines, maritime shipping companies, container shipping companies, ro-ro shipping companies, transoceanic shipping companies, logistics services or courier companies, air freight companies, and the like.

The shipments can be tracked by one or more techniques. The shipment enterprise server 250 can provide position and status updates, such as freight tracking information and freight movement projections between two locations, to the supply and/or logistics chain management system server 204. The shipments can be tracked using an active and/or passive satellite positioning system, such as the Global Positioning System, that includes, in the vehicle, a receiver of position-based signals received from a satellite. A typical shipment tracking system, such as a vehicle tracking system, combines the use of automatic vehicle location in individual vehicles with software that collects the fleet data for a comprehensive picture of vehicle locations. Modem vehicle tracking systems commonly use satellite position information (for example, including information provided from a satellite positioning system (“SPS”), such as GPS, GPRS, GNSS, GLONASS, IRNASS, etc.) technology for locating the vehicle, but other types of automatic vehicle location technology can also be used. In another technique, terrestrial antenna information (such as triangulation) is used to locate a shipment, whether by air, water, rail or road. The shipment vehicle, whether ship, barge, train, truck or airplane, emits an RF signal at periodic intervals enabling position determination by triangulation based on times of receipt at spatially dislocated antennas. The vehicle can also periodically transmit a GPS location signal to a carrier providing current GPS position. The RTLS system can provide information on how fast the shipment is moving (based on changes in position as a function of time) and estimate when the shipment will arrive at its final or intermediate destination. Another possible source of shipment information is real-time satellite feeds, such as Google™ Earth.

The network accessible information source(s) 224 include any source of information relevant to supply and/or logistics chain performance, including, without limitation, social networks such as Twitter™ Firehose™, news sources and/or aggregators (to provide news on current events that may impact positively or negatively the supply and/or logistics chain performance), weather data sources (for example, the National Weather Service, national and local news sources, the Weather Channel™, Weather Source™, worIdweatheronline.com, and the like), governmental entities (such as courts, law enforcement authorities, geological surveys, disaster relief agencies, and the like to provide legal or regulatory changes or requirements, lawsuits, bankruptcy filings, and the like, and other information), and law enforcement or military authorities.

Such information sources can be monitored applying word cloud techniques to one or more information feeds, which graphically represent word usage frequency. Generally, the more frequent a word or group of words is used the greater the likelihood that the fact or event described by the words or group of words exists. The words or group of words can further be weighted for reliability by the source, with law enforcement and military authorities being given a higher or more reliable weighting than news sources. Other automated techniques can be employed. For example, a web crawler is an Internet bot can systematically browse the World Wide Web, typically for the purpose of Web indexing. Web crawlers can copy all the pages or other information they access for later processing by a search engine that indexes the downloaded pages so that users can search them much more quickly. Human agents can also monitor information sources for event related information.

The various servers and sources are connected by a circuit and/or packet switched wide area network (“WAN”) that covers abroad area (for example, any telecommunications network that links across metropolitan, regional, or national boundaries) using private and/or public network transports. An example WAN is the Internet.

While the supply and/or logistics chain is described primarily with reference to manufacturing and distribution of a product, it can be applied equally to warranty and/or repair or maintenance services and logistics and procurement operations. The term “supply and/or logistics chain(s)” and variations thereof are intended to encompass these other types of operations.

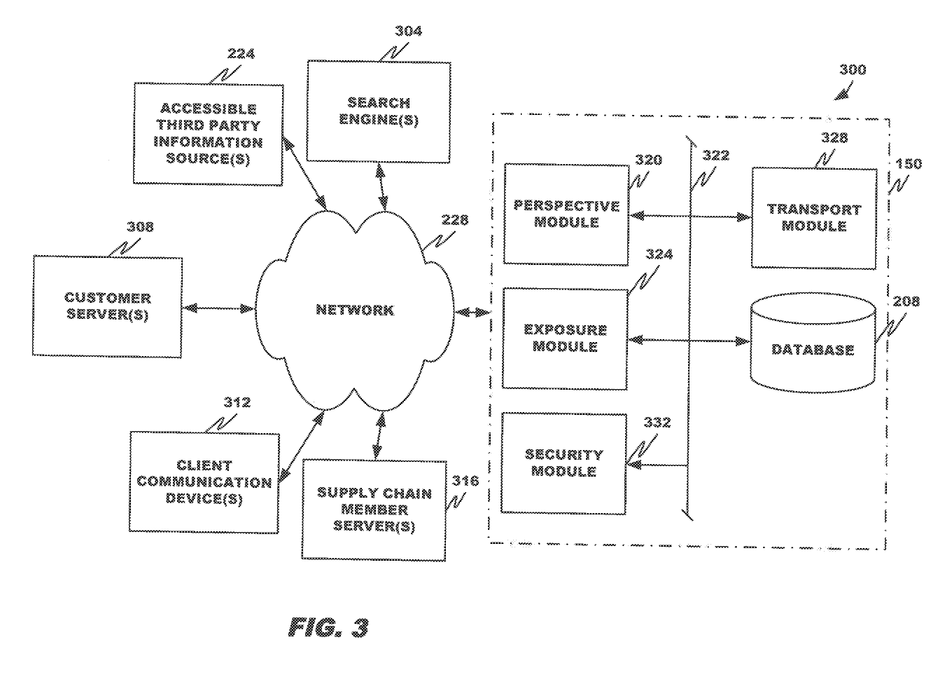

FIG. 3 depicts an example of a supply and/or logistics chain monitoring system 300. The system 300 comprises the supply and/or logistics chain management system 150, search engine(s) 304, accessible third party information source(s) 224, customer server(s) 308 (which, for example, is a server maintained by a brand owner other than an OEM), client communication device(s) 312 (which include any portable or non-portable communication device such as tablet computer, laptop, personal computer, cellular phone, and the like), and supply chain member server(s) 316 (which include tier 1 enterprise server 254, tier 2 enterprise supplier server 212, first, second, . . . nth tier 3 enterprise supplier server 216a-n, and first, second, third, . . . mth tier 4 enterprise supplier server 220a-m), all interconnected by network 228. The supply and/or logistics chain monitoring system 300 can determine, based on past supply and/or logistic chain performance information, a performance rating for a selected object in the supply and/or logistics chain. The performance rating can be based on a scale from lowest performance level to highest performance level. The supply and/or logistics chain management system 150 includes a perspective module 320, an exposure module 324, a transport module 328, a security module 332, and the database 208 connected by a local area network or bus 322.

The Perspective Module 320

The perspective module 320 can monitor the health and operation of a selected supply and/or logistic chain using defined parameters. The user can select one or more KPIs of interest and the module 320 will monitor temporally changes in the values of the KPIs. Examples of KPI metrics include DIFOT (delivery in full and on time), on time shipping/delivery (for example, on time customer shipment, on-time supplier delivery, on-time arrivals, etc.), LIFR (line item fill rate, perfect or error free measurement, customer order to commit cycle time, order cycle time of finished goods, on time supplier orders, days of supply: finished goods, work in process (for example, parts or components), or raw materials, inventory: finished goods, work in process (for example, parts or components), or raw materials (for example, “RAW/WIP/PG” inventories), perfect order fulfillment, total supply cost, supply and/or logistics chain costs as percentage of sales, total supply and/or logistics chain cost per unit sold, warehousing cost, transport cost per unit, labor productivity rates, delivery performance, fill rate, supplier fill rate, order fulfillment lead times, supply and/or logistics chain response time, production flexibility, cycle time, defects per million opportunities or DPMO, shipping accuracy, % orders with products on back order, order compliance, supplier lead-time variability, units of a selected component, part or product produced today, days of supply of such units, component, part or product yields, phase in and/or out of a unit, last time buy of a type of unit, and the like. When a KPI metric rises above or falls below a selected threshold, a warning or other notification can be sent to the user. The perspective module 320 can obviate the needs to send the user spreadsheets or manually copy data between systems. The perspective module 320 can provide a common source of supply chain and/or logistics information across a selected multi-enterprise supply and/or logistics chain, for example, from suppliers, to manufacturers, to distributors, and to carriers. When a selected KPI metric exceeds configured thresholds, for example, dashboard alerts can be provided to specified users.

Dashboard displays can provide users with real-time tracking of selected KPI metrics in a selected supply and/or logistics chain. The displays can be user configurable and include a number of different dashboard elements including: gauges (for example, at-a-glance tracking of high level health indicators), trend lines (with optional thresholds) to view how a selected KPI metric or set of KPI metrics changes over time to get early warning into potential problems, scorecards (with optional breakdowns and thresholds) to track important numerical values or KPI metrics, such as dollars of global inventory, and pie and/or bar charts. The dashboard element can show the KPI metric on an absolute (for example, numerical) or relative (for example, percentage) basis.

The Exposure Module 324

The exposure module 324 can identify and respond to risks in a selected supply and/or logistics chain. It can show a user where and by whom each and every component of a selected product is manufactured, supplied, and distributed. The exposure module 324 enables event risk and operations management throughout the supply and/or logistics chain by constantly tracking selected news sources of global events, such as by social networks, news feeds, governmental statements, and the like. Each news source can have an assigned degree of reliability or reliability ranking for use in determining whether or not to notify designated recipients for a selected supply and/or logistics chain of an event potentially impacting the selected supply and/or logistics chain and, if so, provide designated recipients with an indication of the reliability of the event information. The exposure module 324 can receive a live news feed from selected news sources on what is happening in the world that might impact a selected supply and/or logistics chain. The news feed can bridge over to events.

The exposure module 324 can enable a user to identify and respond to event-related risks in a selected supply and/or logistics chain by knowing immediately what sites, parts, and products may be impacted. The exposure module 324 can enable the user to ping part and component suppliers directly to verify impact and kick-start disruption event mitigation. The exposure module 324 can monitor the selected supply and/or logistics chain with substantial real-time 24-hour, seven-day-a-week, and/or 365 days/year “24/7/365” global event feeds. When a disruption event occurs, the exposure module 324 can geo-locate the failure path against plural points in the selected supply and/or logistics chain and assess a likelihood of impact toward the delivery of products to customers, and, when the likelihood and/or severity of impact is sufficiently high, generate and send to a client communication device 312 an auto-notification containing event information.

The exposure module 324 can determine, by applying risk analysis, whether the event is likely to impact the selected supply and/or logistics chain and provide a warning to the user. The degree of impact can be based on one or more of an event associated risk assigned to the respective tile and a relative degree of impact of the event on the corresponding site, part, component, product, shipment, enterprise, selected order, revenue, profit, etc., compared to a degree of impact of the event on another of the corresponding site, part, component, product, shipment, enterprise, selected order, revenue, profit, etc. The impact calculation can be preconfigured and/or configured by or for customer requirements. Ranking the impacted objects against each other can be done to know which impacted object is a more significant impact to a selected supply and/or logistics chain. This “relative” aspect takes this calculation from a generic risk analysis to a risk analysis configured for a particular set of circumstances and/or supply and/or logistics chain.

The exposure module 324 can provide alive view, which is a focused, real-time view of the disruptions and/or other events impacting manufacturers, suppliers, and/or distribution sites in a selected supply and/or logistics chain. When events occur, the exposure module 324 can display an event perimeter ring, or range of disruption, on the live view map with details showing supply and/or logistics chain failure paths and tier 1-4 enterprise interconnections. For example, as shown in FIG. 4 a disruption event, depicted as an earthquake, can be shown on the map display at a location 408 impacted by the event. The range of disruption 412 is assigned to the disruption event indicating a likely spatial range impacted by the event. As will be appreciated, different event types and events for a given event type can have differing assigned spatial ranges of disruption. For example, an earthquake may have a larger spatial range of disruption than a storm, and an 8.0 earthquake on the Richter scale would have a larger spatial range of disruption than a 5.5 earthquake on the Richter scale A range can be modeled by many techniques, such as by using a shape file. The exposure module 324 can enable the user to drill down by site to view indirect impact of upstream failures or disruptions on products and customers.

The exposure module 324 can enable a user to work through a part or component list for a selected product, starting with single-sourced parts or components for each event that occurs. As the user works through the list, he or she can mark the event severity as none, low, medium, or high, thereby enabling the list to focus on resolving high impact products first.

The exposure module 324 can notify not only the user of an event but also the tier 1 enterprise or tier 2-4 enterprise suppliers (for example, manufacturers and/or suppliers and/or sites) in the event impact zone. In this manner, each tier 1-4 enterprise or impacted site can proactively indicate whether they are impacted (and, if impacted, a degree of impact severity) or in the clear, thereby enabling the user to focus more quickly and effectively on mitigation.

The Transport Module 328

The transport module 328 can enable a user to manage and substantially optimize a global transportation network. It can show a user real-time information for each and every transport object (for example, route segment, shipment, hub (for example, ports, depots, airports, and intermediate transfer points), source load facility, destination unload facility, and carrier m a selected supply and/or logistics chain, even down to individual route segments, thereby enabling the user to anticipate delays and fix them before they impact customers. The module 328 can provide monthly performance reports that compare costs, service level agreements (“SLAs”), and actual shipping times. The module 328 can provide no(only shipment visibility and estimated shipment arrival times but also early warning of delays. It can enable a user take an appropriate action for a late shipment, such as drilling down to identify the root cause and collaborating with the shipper, manufacturer, distributor, assembler, or other supply and/or logistics chain member to resolve the issue or mitigate the impact of the late shipment on the selected supply and/or logistics chain. It can provide the user with a supply and/or logistics chain view showing all of the sites and hubs in a selected supply and/or logistics chain and the routes that connect them. The user can easily filter routes by any selected transport object, such as source or destination site. It can enable a user to select a route by allowing the user to view all the ports, depots, airports, intermediate transfer points, and other hubs along the route and to review and review and compare alternate routes. In one shipment tracking example, a tracking view provides real-time visibility into the shipments flowing through a selected global supply and/or logistics chain. Every shipment, including those still being processed at a site, is visible on an interactive global map. The user can select (for example, by clicking, gesture, or other input) on a site to reveal relevant location and shipment details or select a shipment to reveal details on contents, status, and estimated delivery. The transport module 328 can access historical transit times for intermediate segments and warn a user when a shipment will arrive late—even if the shipment is still en route It can help the user to optimize a selected supply and/or logistics chain transportation network by providing historical analysis of carrier performance. It can use monthly reports that compare costs and actual shipping times to contracted SLAs to manage carriers more effectively.

The transport module 328 can use one or more independent sources, in addition to the freight carrier or shipping company, to determine status and/or location of a selected shipment. One independent source is an RTLS system using a combination of satellite position information (such as a satellite positioning system (“SPS”), for example, GPS and GLONASS) and terrestrial antenna information (such as triangulation) to locate a shipment, whether by air, water, rail or road. The dual use of an SPS and terrestrial antenna information is synergistic. For example, in densely populated, forested, or mountainous areas an SPS can lose accuracy due to signal interference or loss.

The transport module 328 can provide scheduling information, including projected shipment arrival dates for parts, components, and/or products from a first, second, third, or fourth tier enterprise 100, 104, 108, and 112 and required shipment departure dates for parts, components, and/or products. Each of the shipment arrival and departure dates can be linked to a set of data structures describing the shipment, including shipment source and destination, freight carrier, freight tracking information, current shipment status and/or location, shipment contents (by product type and number), date of shipment, and the like). The projected shipment arrival dates can be received from the transport module 328. The shipment departure dates can be determined from the enterprise sourcing the part, component, and/or product.

The supply and/or logistics chain monitoring system 300 can track past performance for a selected object (for example, a tier 1-4 enterprise and/or enterprise site, a transport object such as a freight carrier and/or shipping route, and the like), such as by comparing the actual part, component and/or product shipment arrival or departure date against a selected date (received from the carrier, required by contract or order or SLA, and/or projected by the supply and/or logistics chain monitoring system 300), to evaluate performance of the object, identify seasonal trends, and the like. The past performance for an object (for example, whether tier 1-4 enterprise, tier 1-4 enterprise site, freight carrier, hub, or route segment) can be used to determine and assign a level of confidence in part, component, and/or product deliveries being received by the selected date. The level of confidence, when low, may provide a basis to order additional part, component, and/or product from a more reliable source. The level of confidence can also be based on past performance of each tier 1-4 enterprise or each different facility of a common tier enterprise.

The transport module 328 can substantially optimize a supply and/or logistics chain transportation network by providing periodic (for example, daily) and/or historical analysis of the performance of a transport object. It can enable a user to review, analyze and/or highlight failed shipments, missed arrivals, historical arrival performance, and carrier data quality to monitor the performance of the selected entire global transportation network, even at a glance.

The estimated or projected delivery date for an order can include an associated probability or likelihood and, optionally, an associated range of arrival dates that the pails, components, and/or products in the order will be timely received by the selected arrival date or within the range of arrival dates. The range of arrival dates can be selected using a standard deviation of arrival times based on current and/or historic performance information and/or other relevant information. For example, a historic reliability or probability of timely receipt at a destination facility from the selected lower tier enterprise supplier site, and optionally associated standard deviation of historic receipt dates for the parts, components, and/or products relative to a target date, can be used to provide the probability and optionally standard deviation of the destination facility receiving a current shipment from the selected lower tier enterprise supplier site. It can be determined using carrier provided estimates. It can be determined using actual real time tracking of the current shipment location and an estimate of how long the shipment will require to transit the remainder of the route (including route segments and hubs).

The Security Module 332

Security over the wide area network 228 is managed by the security module 332 to protect transmitted information. As set forth in co-pending U.S. application Ser. No. 13/935,209, which is incorporated herein by this reference, the security module 228 routes every data query through a single “Platform Query” entry point that enforces appropriate security constraints. Access to objects and records can be controlled at the user, role, organization, and enterprise level. A user can specify access based on the relationship among multiple enterprises. For example, if companies A and B are two OEMs that outsource manufacturing to a selected company C and if company A wants to share order information with a selected carrier company, company A can share the information even if company B has a different agreement with company C that does not allow the selected carrier company to see company B's orders. The security module 332 can enable the collected information to be maintained in one data location (and common database) without the use of a partitioned database. This can enable the use of a simpler data model that enables ease of constructing relationships between enterprises, provides stability, and provides scalability. Each data row of the model can have a different schema. The data model can also enable sharing of information across and among different supply and/or 5 logistics chains.

The security module 332 can further provide cloud security, such as secure client connectivity with extended validation (“EV”) certificates, OpenID challenge/response client authentication, user-specific authorization tokens, database/application separation, support for secured socket layer (“SSL”) encryption of API calls, separation of credential storage with no credential access from interface zones, and mechanisms to prevent data spoofing and query injection.

The Database 208 and Database Management System

The database contains supply and/or logistics chain performance information collected from tier 1, 2, 3, and/or 4 enterprises and freight companies in the supply and/or logistics chain and from accessible information source(s) 224. A database management function can store, update and otherwise manage the data in the database 208 in accordance with a selected data model. The data structures are typically associated with one or more enterprises (for example, material supplier, part/component manufacturer, product assembler, freight or shipping company, distributor, brand owner, wholesaler, and/or retailer) in the supply and/or logistics chain. Transactional documents, such as purchase orders, material safety data sheets, and bills of material, and agreements, such as supply and/or manufacturing agreements, or RMAs, and SLA's, contain references to all owners down the organization level, have corresponding role types and functions specified (for example, only a buyerRole can change requestQuantity field), and include preferences and settings referenced to an appropriate level (for example, enterprise (or the part of the enterprise involved in the supply and/or logistics chain transaction), user, etc.).

The database 208 can include, for each selected enterprise in the supply and/or logistics chain (for example, each tier 1, 2, 3 or 4 enterprise), name, geographical location of corresponding sites, geopolitical location of corresponding sites, material, part, component, current spot market and/or contractual sales price of the material, part, component, and/or product type supplied by the enterprise, respective supply and/or logistics chain performance metrics of the enterprise and/or each site of the enterprise, material, part, component, and/or product supply and/or purchase commitment with another enterprise in the supply and/or logistics chain, specifications and requirements for material(s), part(s), component(s), and/or product(s) supplied and/or purchased by the enterprise, bills of materials for materials, pails, components, and/or products, material, part, component, and/or product quantity and shipment dates and expected arrival dates at the next enterprise in the supply and/or logistics chain, order cycle and/or turnaround times, shipment and/or order volume, total number of shipments, number of on time shipments, number of late shipments, order mismatch count, repair details, and an association of the selected enterprise with one or more other enterprise(s) in the supply and/or logistics chain, such as by a contractual or other supply relationship.

Relevant data types for the event can include not only the event category, type, subtype, and severity but also objects impacted by the event, such as number of materials and/or or parts and/or components and/or products impacted, number of downstream parts and/or components and/or products impacted (such as the parts and/or products supplied to the tier 1 enterprise 104), potential financial impact on all or part of the supply and/or logistics chain, and a number of supply and/or logistics chain sites affected.

While any data model and database management system can be employed, the database 208 management system typically uses a NoSQL database. As will be appreciated, a NoSQL database provides a mechanism for storage and retrieval of data that is modeled in means other than the tabular relations used in relational databases.

The Microprocessor Executable Components of the Transport Module 328

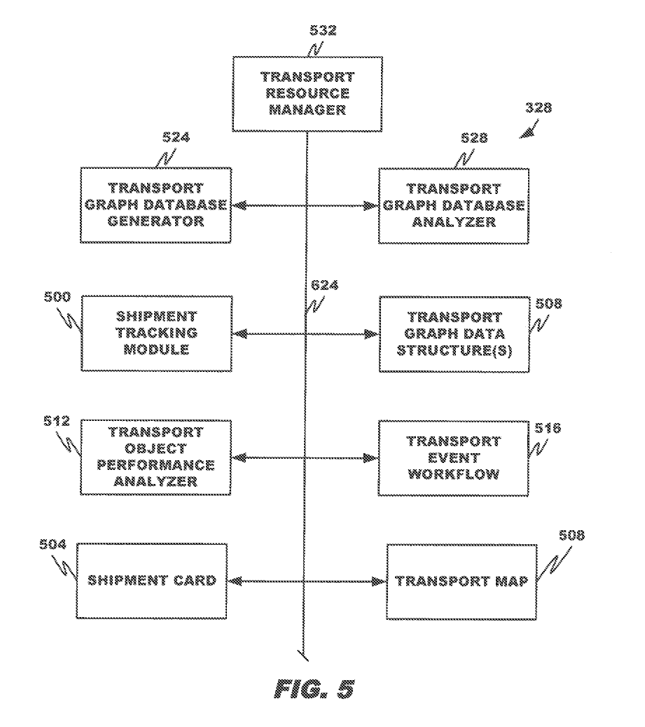

With reference to FIG. 5, the transport module 328 includes a number of computational modules and data structures, including: a shipment card 504 containing descriptive parameters and other information for a corresponding shipment (which descriptive parameters can include one or more of shipment identifier, shipment carrier, shipment transportation mode (for example, rail, air, ship, or truck), shipment contents (for example, type and/or identification of items and corresponding quantities), shipment origin, shipment destination, shipment timestamp for last update to the shipment card 504, current and/or projected shipment time and/or duration and/or status (for example, number of days delayed, on time, or number of days early relative to a projected shipment arrival time), and links or pointers to the transportation objects involved with the shipment); a transport map 508, such as depicted in FIG. 4, depicting a selected supply and/or logistics chain, including transport objects; a transport object performance analyzer 512 (hat analyzes a performance of a selected transport object relative (o predetermined rules, objectives, policies, and/or performance thresholds; a transport event workflow 516 which is a se(of procedures and rules instantiated for an underperforming transport object; a shipment tracking module 500 which tracks a spatial location of a shipment at any point in time; a set of transport graph data structure (s) 508 that describe transport objects and their interrelationships; a transport graph database generator 524 that observes, over time, performance of a selected supply and/or logistics chain, including shipment routes, carriers, origins and destinations and transport object performance data for each transport object, and creates and/or updates dynamically the set of transport graph data structure(s) 508 corresponding to the selected supply and/or logistics chain; a transport graph data base analyzer 528 that traverses the set of transport graph data structure(s) 508 corresponding to the selected supply and/or logistics chain to provide information to a transport resource manager 532 about sole and alternate routes and transport object performance; and the transport resource manager 532 that, for an unacceptably performing or underperforming transport object, determines a degree of impact of the underperformance on a selected supply and/or logistics chain and/or recommends one or more alternatives to mitigate the effect of the underperformance.

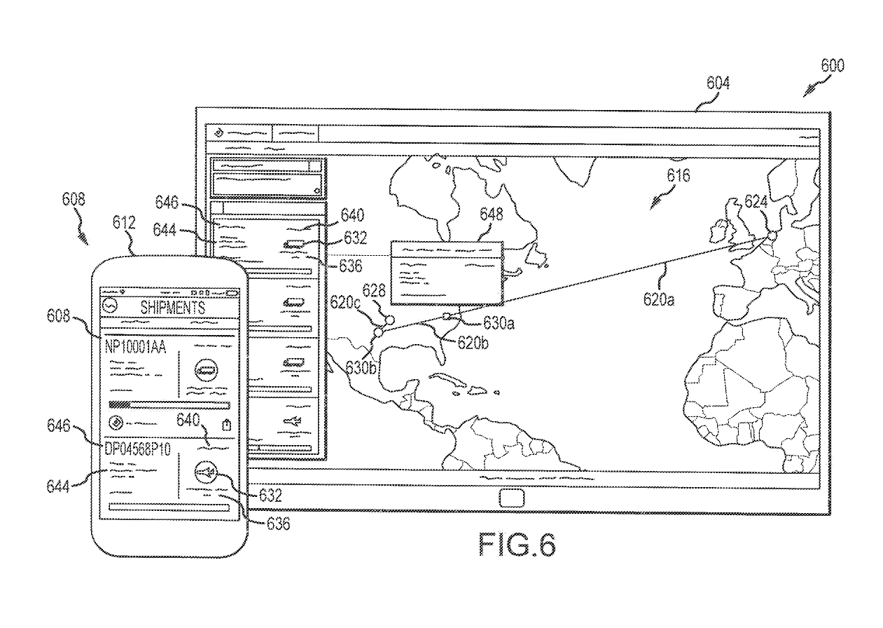

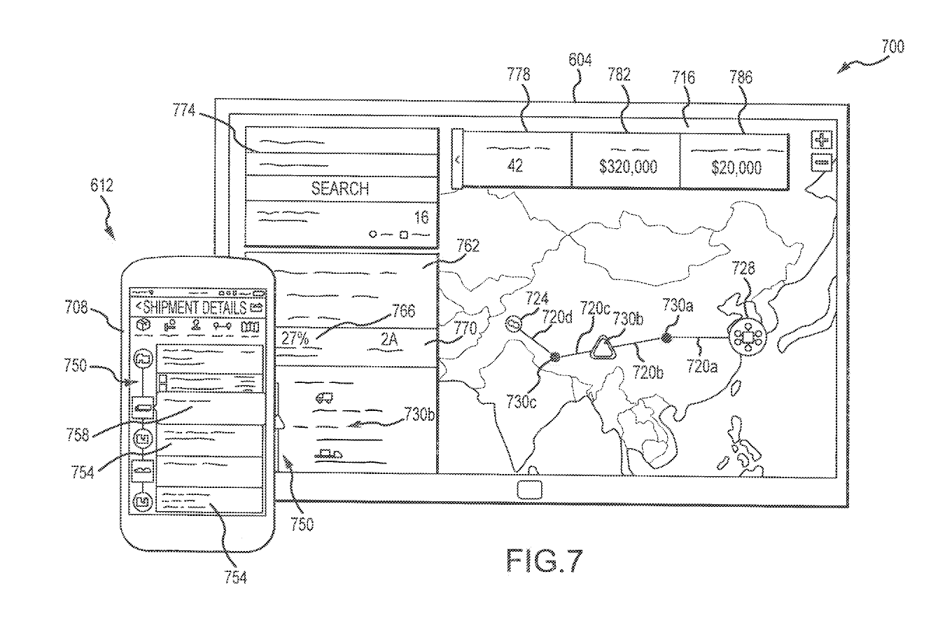

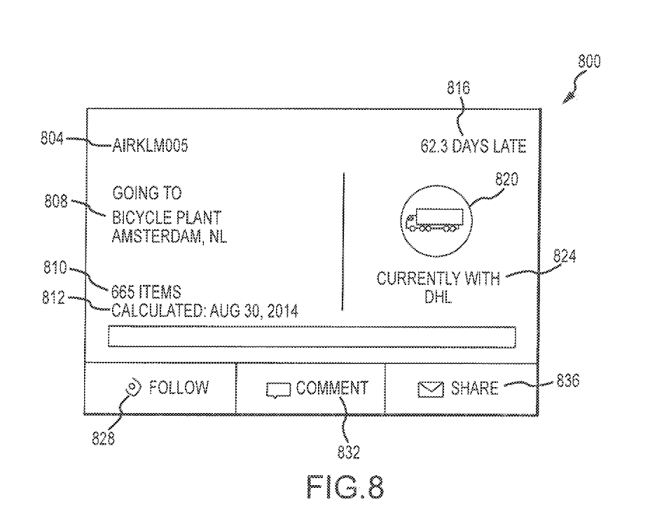

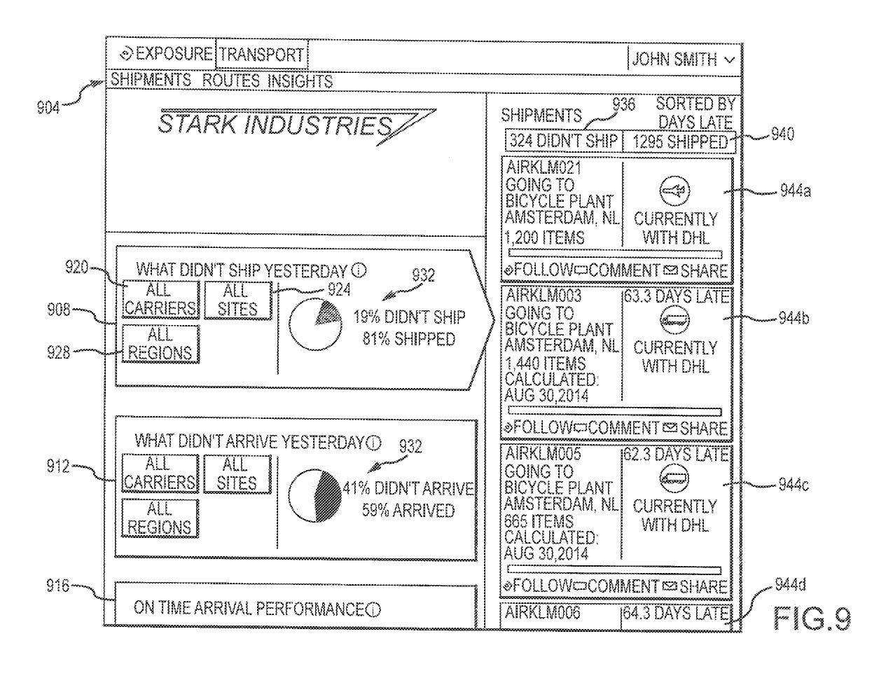

FIG. 6, FIG. 7, FIG. 8, FIG. 9 depict various user displays provided by the transport module 328.

Referring to FIG. 6, the transport module 328 provides a first display 600 on a display 604 of a computer, such as a personal computer or laptop, and a second display 608 on a mobile communication device 612, such as a cellular phone or tablet computer. The first and second displays arise from a common set of information. The first display 600 shows transport map configuration different from that of FIG. 4. The map 616 shows a plurality of transport objects associated with selected shipment. The transport objects include plural route segments 620a-c, shipment source or origin facility 624, shipment destination facility 628, and intermediate transfer points 630a,b. The left of the first display 600 provides a description of each transport object. Each description includes an icon 632 indicating whether the corresponding route segment is by truck, rail, plane or ship, carrier 636 and shipment identifier 646 for the corresponding route segment, shipment status 640 (for example, number of days delayed, on time, or number of days early relative to a projected shipment time over the corresponding route segment), and a description 644 of the quantity and items in the shipment. The route segments 620a-c each correspond to a different shipment mode, namely air for route segment 620a and truck for each of route segments 620b and c. The displayed box 648 indicates that the shipment is currently at intermediate transfer point 630a and contains information in the shipment card 504 for the corresponding shipment. The second display 608 includes the information on the left side of the first display 600, including the icon 632 indicating whether the corresponding route segment is by truck, rail, plane or ship, the shipment identifier 646 and carrier 636 for the corresponding route segment, shipment status 640 (for example, number of days delayed, on time, or number of days early relative to a projected shipment time over the corresponding route segment), and a description 644 of the quantity and items in the shipment.

Referring to FIG. 7, the transport module 328 provides a first display 700 on a display 604 of a computer, such as a personal computer or laptop, and a second display 708 on a mobile communication device 612, such as a cellular phone or tablet computer. As in FIG. 6, the first and second displays arise from a common set of information. The first display 700 shows a transport map configuration different from that of FIG. 4. The map 716 shows a plurality of transport objects associated with a selected shipment. The transport objects include plural route segments 720a-d, shipment source or origin facility 724, shipment destination facility 728, and intermediate transfer points 730a-c. The left of the first display 700 and the second display 708 show the shipment route 750 (formed by the various subcomponent transport objects) as a vertical line subdivided by nodes corresponding to the source or origin 724, intermediate transfer points 730, and destination 728 to form route segments 720a-d. Each node has a corresponding description 754 indicating a type and name of the respective node (for example, source facility, destination facility, port, airport, depot, packaging facility, load transfer facility, etc.), and each route segment has a corresponding description 758 indicating a type and name of a freight carrier carrying the shipment over the respective route segment. The first display 700 further includes a carrier description 762 providing the name of the selected carrier, historical performance of the carrier 766 (for example, 27 percent on time deliveries), and a current delay 770 (24 days) in the shipment attributable to the carrier. The first display 700 further has a triangular icon for hub 730b indicating that the hub is underperforming (or has become a chokepoint or bottleneck for the shipment potentially causing substantial delay in the shipment). The left of the first display 700 shows the hub on the route representation. The left of the first display 700 further shows a search query box 774 that enables a user to search on any information field in a transport object description. The upper portion of the first display 700 includes a number of information fields. In some embodiments, the first information field 778 may correspond to a number of shipments in route, the second information field 782 may correspond to an inventory value or other shipping cost associated with one or more points along a route, and the third information field 786 may correspond to other cost and/or values associated with a particular route, inventory, carrier, parts of a particular route, etc. It should be appreciated that these information fields may change, and even present different information, depending on route, route portion, carrier, inventory, source, and/or destination selected.

The display 800 of FIG. 8 is an example shipment notification displayed, by a client communication device 612, for a selected shipment. The notification effectively presents visually the shipment card 504 for a selected shipment. The information includes shipment identifier 804 (AIRKLM005), shipment destination 808 (bicycle plant in Amsterdam, NL), number of items in the shipment 810 (665 items), date of last shipment card update 812 (Aug. 30, 2014), current status of the corresponding shipment 816 (62.3 days late), shipment type icon 820 (for example, truck), and carrier identifier 824 (DHL). The selectable icons at the bottom of the display 800 enable the user to follow (icon 828) the progression of the shipment (which, if selected, will provide periodic updates to the user when a field on the shipment card changes), publish a comment (icon 832) regarding the shipment. (which comment can be viewed by others and provide additional information about the shipment), and share (icon 836) the display 800 with another by a messaging modality, such as text, email, a short message service, Twitter™, and the like.

The display 900 of FIG. 9 depicts further information provided by the transport module 328. The tool bar 904 gives the user the option of selecting shipments, routes, and insights (selected for display 900). “Shipments” provides information on each shipment in the selected supply and/or logistics chain, “routes” provides information on each transport object (for example, route segment, hub, carrier, etc.) in each route in the selected supply and/or logistics chain, and “insights” provides analytical results regarding shipment performance for the selected supply and/or logistics chain. The left of the display 900 provides fields for “What Didn't Ship Yesterday” 908, “What Didn't Arrive Yesterday” 912, and “On Time Arrival Performance” 916. Each of these fields provides options for “All Carriers” 920, “All Sites” 924, and “All Regions” 928) and provides a pie chart or other graphical representation 932 of the pertinent results for each field (e.g., for field 908 19% of all shipments for the selected one of the carriers, sites, or regions did not ship yesterday while 80% shipped and for field 912 41% of all shipments for the selected one of the carriers, sites, or regions did not arrive yesterday while 59% arrived). The right of the display 900 includes summaries 936 and 940 for the shipments that did not ship (324) and that did ship 1296). Below the summaries is a scrollable listing of shipment cards 944a-d configured as discussed above with reference to FIG. 8.

A display selector (not shown) controls the display and the display configuration and selects the information displayed to the user. The display selector controls the pixels in the display to produce a desired graphical image, such as any of the displayed content above.

The Transport Graph Data Structures 508

The transport graph data structures 508 describe transport objects and their interrelationships. The transport graph database generator 524 observes, over time, performance of a selected supply and/or logistics chain and creates and updates the set of transport graph data structure(s) 508 corresponding to the selected supply and/or logistics chain to reflect changes in shipment behavior for the selected supply and/or logistics chain over time. The transport graph data base analyzer 528 traverses the set of transport graph data structure(s) 508 corresponding to the selected supply and/or logistics chain to identify alternate route segments and/or hubs in the event an underperforming transport object adversely impacts or likely will adversely impact shipment performance for selected shipment.

The graph data structures 508, which are used in mitigating reactively or proactively unacceptable performance in a transport object, is a tree-type structure with nodes and node connecting branches. Each node represents a transport object or item, including without limitation a source or origin facility for a shipment, the shipment itself, a shipment enterprise or freight carrier for the shipment, a route segment, a hub, person, a chokepoint or bottleneck (due to an underperforming transport object), or a shipment status (for example, on time, delayed, or early). Each node is associated with a description of the corresponding object (for example, identification of a carrier for a carrier transport object, type of transportation mode for a route segment (such as air, ship, rail, or truck), type (for example, port, airport, truck depot, rail depot, etc.) and location of hub, and historical performance information) and can be color coded by associated enterprise. Each interconnecting branch indicates a type of relationship between the respective interconnected nodes, including without limitation, “alternate” for alternate transport object (for example, alternative carrier, alternative route segment, alternate hub, etc.), “sole” for sole transport object (for example, sole carrier, sole route segment, sole hub, etc.), “ship to” for shipment to destination, and “works” for or employed by, “emergency contact”, and “knows” for business association. The graph data structures can divide the items in the supply chain so as to generate a set of graph data structures for a specific transport object (for example, shipment, carrier, hub, etc.), such that a user can view selectively the upstream and downstream segments of the supply and/or logistics chain responsible for shipping a selected part, component, or product. This is opposed to a site-centric or site-level view, which shows all parts, components, and products shipped by each depicted site, which, for sites shipping multiple different parts, components, or products, can produce a very complex and difficult-to-traverse graph database. The use of a part, component, or product-centric set of graph data structures can not only provide a simpler graph database to traverse by omitting objects in the supply and/or logistics chain that are not of interest to the user but also enable users to view how a selected part or component flows through the supply and/or logistics chain.

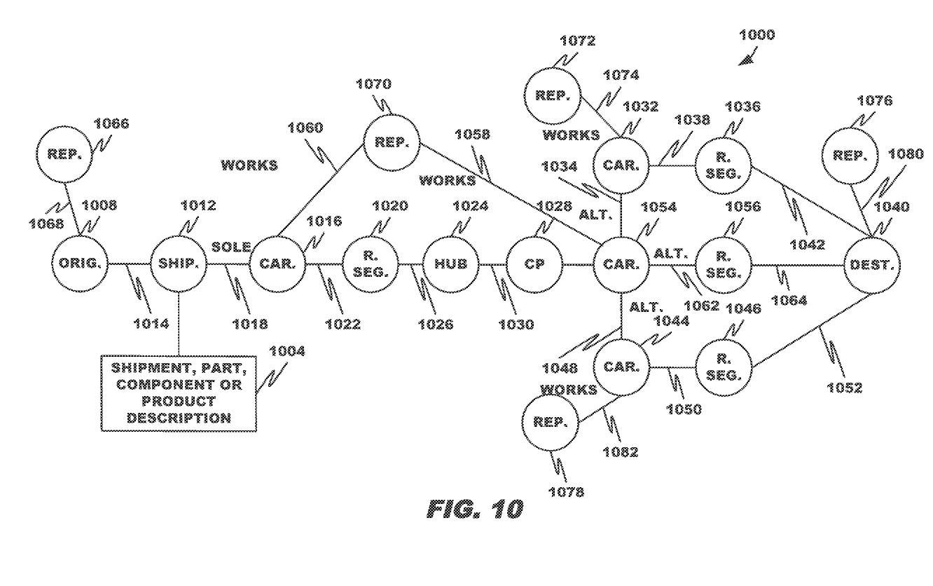

FIG. 10 demonstrates an example of display 1000 showing graph data structures 508. In FIG. 10, the rectangular node 1004 refers to a description of the selected shipment or portion thereof (for example, part, component, or product in the shipment). The circular nodes are identified as follows: node 1008 as “ORIG.” (which identifies the shipment origination or source facility), node 1012 as “SHIP.” (which is the shipment of interest and, as shown by branch 1014 the shipment would originate at the facility corresponding to circular node 1008), node 1016 as “CAR.” (which would be the carrier for the shipment of interest), node 1020 as “R. SEG.” (which is the sole route segment for the shipment of interest and, as shown by branches 1018 and 1022 the carrier would be responsible for the shipment of interest over the route segment associated with node 1020), node 102.4 as “HUB” (which, as shown by branch 1026, would be a huh for the shipment at the other end of the route segment associated with node 1020), node 1028 as “CP” (which, as shown by branch 1030, indicates that the hub corresponding to node 1024 is currently a chokepoint or bottleneck), node 1032 as “CAR.” (which is a possible carrier for the shipment of interest and a different carrier than the carrier associated with node 1016), node 1040 (which is the destination facility for the shipment of interest), node 1036 as “R. SEG.” (which is a possible route segment for the shipment of interest and, as shown by branches 1034, 1038, and 1042 the carrier associated with node 1032 would be responsible for the shipment of interest over the route segment associated with node 1036), node 1044 as “CAR.” (which is a possible carrier for the shipment of interest and a different carrier than the carrier associated with node 1016), node 1046 as “R. SEG.” (which is a possible route segment for the shipment of interest and, as shown by branches 1048, 1050, and 1052 the carrier associated with node 1044 would be responsible for the shipment of interest over the route segment associated with node 1046), node 1054 as “CAR.” (which is a possible carrier for the shipment of interest and, as shown by branches 1058 and 1060, is the same carrier as the carrier associated with node 1016), and node 1046 as “R. SEG.” (which is a possible route segment for the shipment of interest and, as shown by branches 1062 and 1064, the carrier associated with node 1054 would be responsible for the shipment of interest over the route segment associated with node 1056). The “ALT” descriptor indicates that route segments 1036, 1056, and 1046 are alternate route segments from hub 1024 to destination 1040, and the “SOLE” descriptor indicates that route segment 1020 is the sole route segment from origin 1008 to huh 1024. Nodes 1066, 1070, 1072, 1076 and 1078 are representatives or contacts for each of his or her related entities, which, for node 1066, is the origin facility 1008 as shown by branch 1068, for node 1070, is the carrier corresponding to nodes 1016 and 1054 as shown by branches 1060 and 1058, for node 1072, is the carrier corresponding to node 1032 as shown by branch 1074, for node 1078, is the carrier corresponding to node 1044 as shown by branch 1082, and for node 1076, is the destination facility 1040 as shown by branch 1080. As can be seen from the above, branches and/or nodes can include embedded comments to describe not only the nature of the relationship but also describe or comment on one or more of the interconnected items, such as the level of expertise or helpful of a person based on previous interactions regarding site performance or risk mitigation. As will be further appreciated, each of the nodes and branches can be further linked to data structures relating to the corresponding branch or node.

The Shipment Tracking Module 500

The shipment tracking module 500 tracks a selected shipment and monitors its status, whether the shipment is on time, early or delayed.

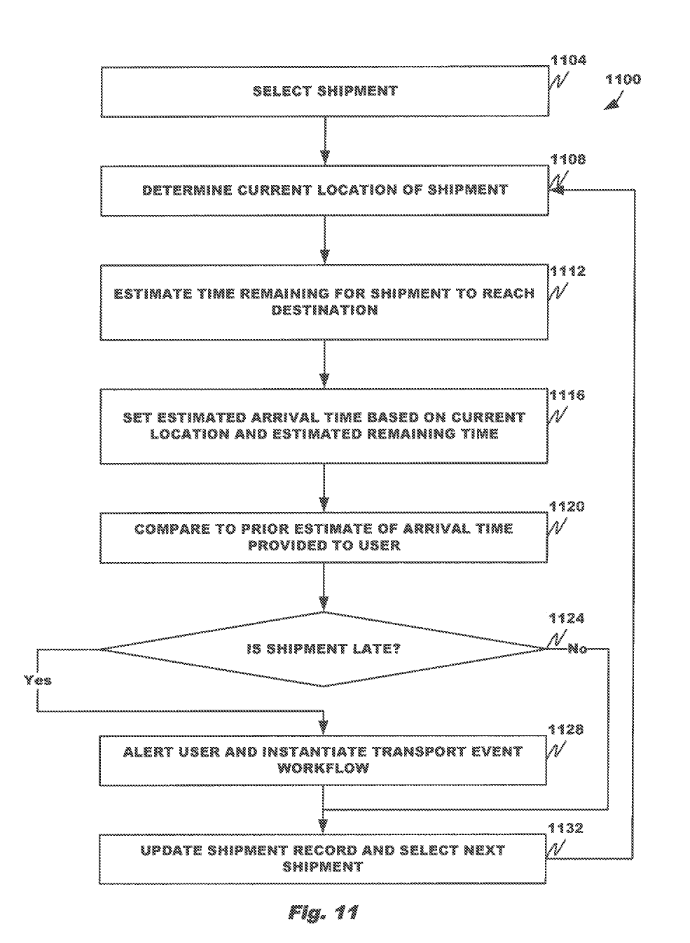

FIG. 11 depicts an operational embodiment of the shipment tracking module logic 1100.

In step 1104, the shipment tracking module 500 selects a shipment.

In step 1108, the shipment tracking module 500 determines the current location of the selected shipment. This can be done, as noted, by an RTLS system using one or more of an active and/or passive satellite positioning system, such as the Global Positioning System, a vehicle tracking system which combines the use of automatic vehicle location in individual vehicles with software that collects the fleet data for a comprehensive picture of vehicle locations, realtime satellite feeds, such as Google™ Earth, or terrestrial antenna information (such as triangulation).

In step 1112, the shipment tracking module 500 estimates the time remaining for the selected shipment to reach the destination facility (or a selected waypoint). As will be appreciated, the RTLS system providing location information to the shipment tracking module 500 can provide information on how fast the shipment is moving (based on changes in position as a function of time) and estimate when the shipment will arrive at its final or intermediate destination. The shipment tracking module 500 can alternatively or additionally consider in its time estimates one or more of the time required by one or more other shipments in temporal proximity to the current time to traverse each of the transport objects between the current spatial position of the shipment and the destination facility, the current levels of performance of each of the transport objects between the current spatial position of the shipment and the destination facility, the estimate provided by the carrier as to shipment arrival time at each of the hubs between the current spatial position of the shipment and the destination facility, and weather and/or road conditions and traffic levels at each of the intervening hubs and route segments, and other similar information.

In step 1116, the shipment tracking module 500 sets an estimated arrival time at the destination facility (or optionally at an intervening hub or other waypoint) based on the current location and estimated remaining time to arrive at the selected endpoint or waypoint. This can be done using one or more of the techniques mentioned in step 1112. When multiple techniques are employed, an average, mean, median or mode can be employed. A standard deviation in the estimate can also be provided.

In step 1120, the shipment tracking module 500 compares the estimated arrival time with a prior estimated arrival time provided to or a target arrival time required by the user.

In decision diamond 1124, the shipment (racking module 500 determines whether or not the selected shipment is late.

When the shipment is late, the shipment tracking module 500, in step 1128, alerts the user and instantiates a transport event workflow 516. A common workflow includes a notification, such as shown in FIG. 8, communicated to one or more communication devices of the user or other designated recipients and a command to the transport resource manager to analyze the risk to the supply and/or logistics chain and recommend to the user one or more risk mitigation strategies (discussed below).

When the shipment is not late or after step 1128, the shipment tracking module 500, in step 1132, updates the shipment card for the selected shipment and selects a next shipment for analysis and repeats the steps above. The shipment card 504 is the set of data structures containing information associated with the selected shipment.

The Transport Object Performance Analyzer 512

The transport object performance analyzer 512 analyzes a performance of a selected transport object relative to predetermined rules, objectives, policies, and/or performance thresholds. Different types of transport objects can have differing definitions of what is required for acceptable or unacceptable performance. For a given transport object, different levels of performance or underperformance can be defined, each with a different consequence or workflow. For example, the transport object performance analyzer 512 can determine that a selected hub or route segment constitutes a bottleneck or chokepoint for movement of a current or planned shipment. When a current shipment is involved, the transport object performance analyzer 512 can instantiate a transport event workflow 516 involving the transport resource manager 532 to identify and/or recommend one or more alternative transport objects to mitigate the effect of an underperforming or unacceptably delayed shipment on the corresponding supply and/or logistics chain.

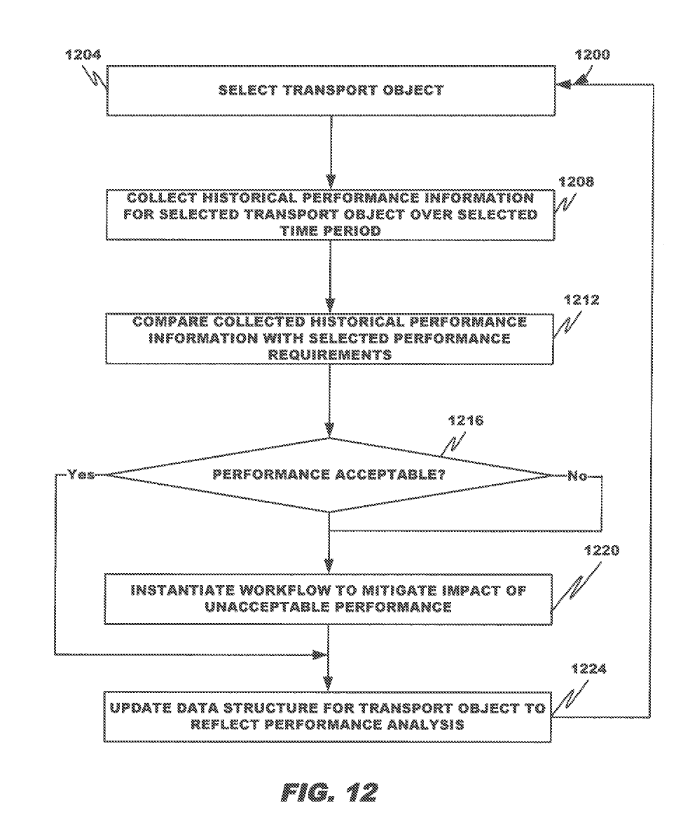

FIG. 12 depicts an operational embodiment of the transport object performance analyzer 512 logic 1200.

In step 1204, the transport object performance analyzer 512 selects a transport object for analysis. The transport object can be any transport object, including without limitation an origin facility (for example, the time required to load a shipment), destination facility (for example, the time required to unload the shipment on arrival), route segment, hub, carrier, and the like.

In step 1208, the transport object performance analyzer 512 collects historical performance information for the selected transport object over a selected time period. The historical performance information can be the time required to traverse a route segment, the time interval required for the shipment to enter and exit a hub, the time interval required by the destination facility to unload a shipment (for example, the time interval between goods on-hand and booking on-hand notifications or between goods on-hand and goods received notifications, etc.), and the time interval required by the originating facility to load a shipment (for example, the time interval between receipt of the order and removal of the ordered goods for shipment, the time interval between receipt of the order and shipment pick-up notification, and the like).

In step 1212, the transport object performance analyzer 512 compares the collected historical performance information for the selected transport object with selected performance requirements, policies, rules or goals. In one embodiment, a hub is determined to be operating acceptably if at least a specified number or percentage of the shipments received by the hub within a first specified period exit the hub within a second specified period (which first and second specified time periods can be the same or different). In one embodiment, a route segment is determined to be operating acceptably if at least a specified number or percentage of the shipments passing over the route segment within a third specified period exit the route segment within a fourth specified period. A destination facility is determined to be operating acceptably if at least a specified number or percentage of shipments received by the destination facility within a fifth specified period have an inter-notification time period falling within a selected time interval. In other embodiments, performance is acceptable when an average, mean, median, or mode performance parameter measured over a selected time or time interval for the selected transport object satisfies an acceptable performance threshold. In another technique, performance is acceptable when at least a threshold percentage of shipments pass through the transport object within a standard deviation of a target time. Other techniques for measuring acceptable performance will be obvious to one of ordinary skill in the art.

In decision diamond 1216, the transport object performance analyzer 512 determines whether or not the performance is acceptable. As will be appreciated, a transport object can perform acceptably in a first time period and unacceptably in a later second time period or vice versa. As will be appreciated, the determination is frequently dynamic and changes over time.

When performance is not acceptable, the transport performance analyzer 512, in step 1220, instantiates the transport event workflow 516 to mitigate the impact of the unacceptable performance. The transport event workflow 516 is a set of procedures and rules instantiated for an underperforming transport object and can include automatic notifications to specified users associated with the selected supply and/or logistics chain, assigning mitigation tasks to specified users, automatic tracking and reporting selected users on the status of the unacceptably performing transport object and the success of any mitigation, maintaining a log of actions or communication thread of communications exchanged regarding the unacceptably performing transport object, determining the degree of impact of the unacceptable performance on other shipments, recommending alternative sets of transport objects to circumvent the unacceptably performing transport object, and the like.

When performance is acceptable or after step 1220, the transport performance analyzer 512, in step 1224, updates the data structure for the transport object and/or shipment card to reflect the performance analysis and returns to step 1204.

In one embodiment, the performance history of each transport object is maintained for a selected monitoring time period and used to grade or rate performance of transport objects (compared to other transport objects of the same or different types) by day, week, month, season, year and the like. The transport objects can be, for example, a carrier's performance on all route segments or just on a selected route segment, a route segment's performance for all carriers or just a selected carrier, or a hub's performance for all carriers or route segments or just for a selected carrier and/or route segment. The user could use the maintained performance history in selecting a set of transport objects (for example, carrier, route segments, hubs, etc.) to use for a selected shipment. As the user selects the transport objects to be used by the shipment, a projected shipment time and arrival date at the destination (based on the performance history of each set of transport objects potentially involved in a shipment) could be provided to the user. This could be done for different configurations of sets of transport objects potentially used for the shipment to enable the user to select an optimal or near optimal combination of transport objects for achieving the user's objectives and/or requirements for the shipment.

In one embodiment, the shipment tracking module and transport object performance analyzer monitor performance of sets of transport objects for multiple supply and/or logistics chains and share the performance data with the different operators of the supply and/or logistics chains. The operator could choose whether or not to add the recommended set of transport objects, by the transport graph database generator 524, to the transport graph data structures for the operator's supply and/or logistics chain.

The Transport Resource Manager 532

The transport resource manager 532, for an unacceptably performing or underperforming transport object, determines a degree of impact of the underperformance on a selected supply and/or logistics chain and/or identifies and/or recommends one or more alternative transport objects to mitigate the effect of the underperformance or unacceptably delayed shipment on the corresponding supply and/or logistics chain. For example, if a route segment or hub is underperforming due to traffic congestion the transport resource manager 532 can select and/or recommend one or more alternate transport objects, such as hub(s) and/or route segment(s), by which to redirect an existing product, part, or component shipment. Prior to shipment, the transport resource manager 532 can recommend to a supply and/or logistics chain one or more preferred transport objects to employ based on current and/or historic performance of the corresponding transport object. For example, the transport resource manager 532 can select a hub and/or route segment that, for the time period for example, season, month, week, etc.) of shipment, has comparatively better performance than other competing or alternative hub and/or route segments.

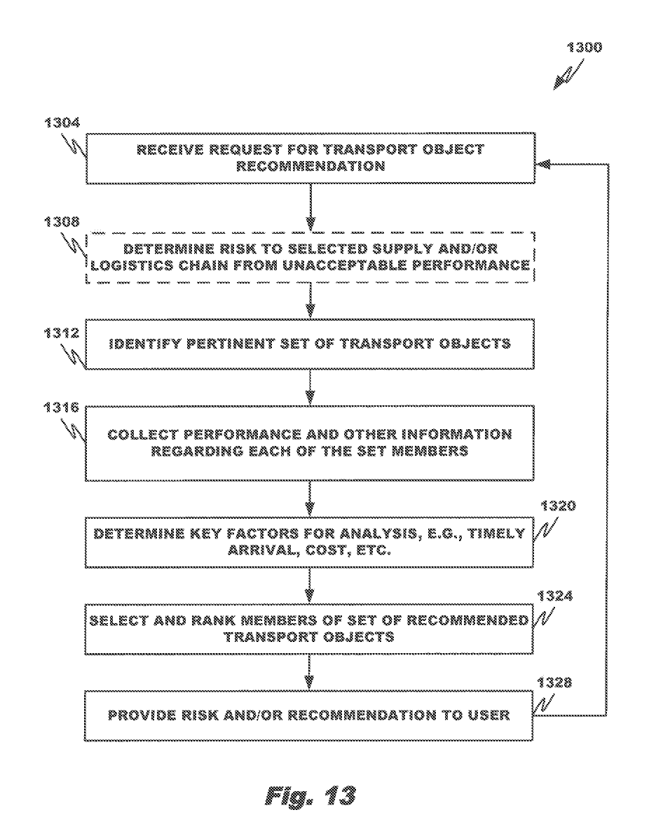

FIG. 13 depicts an operational embodiment of the transport resource manager 532 logic 1300.

In step 1304, the transport resource manager 532 receives a request for a transport object recommendation and/or impact assessment due to an underperforming transport object. This can be received directly from a user or from another part of the transport module 328 in response to a determination that a transport object is not performing acceptably.

In optional step 1308, the transport resource manager 532 determines a risk to a selected or corresponding supply and/or logistics chain from unacceptable performance of the selected transport object. The risk may be for a current shipment or prospective or possible shipment. For example, if a hub were to be performing unacceptably, such as to become a chokepoint or bottleneck, the transport resource manager 532 would determine what supply and/or logistic chains were using the hub and, for each supply and/or logistic chain, a possible or probably financial impact on the corresponding supply and/or logistics chain caused by the concomitant shipment delays. If a carrier were to be performing unacceptably, such as to become a chokepoint or bottleneck, the transport resource manager 532 would determine what supply and/or logistic chains were using the carrier and, for each supply and/or logistic chain, a possible or probably financial impact on the corresponding supply and/or logistics chain caused by the concomitant shipment delays of the carrier. If a shipment were to be performing unacceptably, the transport resource manager 532 would determine, for the supply and/or logistic chain associated with the shipment, a possible or probably financial impact on the corresponding supply and/or logistics chain caused by the consequent shipment delays.

The transport resource manager 532 risk can determine the risk by traversing a set of graph data structures defining the selected supply and/or logistics chain, evaluating the financial impact of the event on the selected supply and/or logistics chain, and determining a risk or probability associated with the risk impact, thereby enabling a user to determine whether a workflow associated with the unacceptable transport object performance should be escalated. The graph data structures map the impacted sites and shipments against the parts, components, and/or products produced or supplied by the impacted sites or carried by the impacted shipments to determine impact information, such as a degree of impact on each site, shipment, part, component and product and/or a severity or risk associated with the overall impact of the selected underperforming transport object on the corresponding supply and/or logistics chain.

The transport resource manager 532 normally applies a supply chain risk analysis in the context of the transport object. The transport resource manager 532 can draw on the following metrics determined for each object.

Number of final products or finished goods at risk per shipment based on the parts and sole sourced parts in the shipment for the selected enterprise customer's supply and/or logistics chain. This calculation determines the unique interconnectivity of the selected shipment's parts to the end user's products.

Profit (or revenue) generated from the products-at-risk (from metric number 1). The profit generated from the products which the parts at the impacted shipment go into is aggregated and normalized across all at-risk shipments. The higher the value, the more risk from the parts in that shipment. The profit from finished goods made out of parts in the at risk shipment is aggregated.

Aggregated part information per shipment: The color is determined by looking at the individual parts within the shipment and determining the aggregate component lead time−[(inventory on-hand+inventory in-transit)/daily component consumption]=Adjusted lead time (ALT). The higher the ALT values above zero, the longer the expected shortage in part supply before new orders can fulfill demand.

The transport resource manager 532 can provide a relative transport impact map showing the impact of the underperforming transport object on a selected supply and/or logistics chain. The relative transport impact map can have multiple tiles, with each tile corresponding to a shipment. The location of a tile for a shipment is based on metric (1), the size of the shipment's tile is based on metric (2), and the color of the shipment's tile is based on metric (3). The map provides users with a visual guide to what shipments are currently having the greatest adverse impact on supply and/or logistic chain performance so that the user can focus his or her mitigation efforts on those shipments first.

In step 1312, the transport resource manager 532 identifies a pertinent se(of transport objects to be considered in determining one or more recommendations. With reference to FIG. 10, for example, if the transport object performing unacceptably were the carrier 1054 or route segment 1056, the transport resource manager 532 would select, for analysis, carrier 1032 and route segment 1036 as a first option and carrier 1044 and route segment 1046 as a second option.

In step 1316, the transport resource manager 532 collects performance and other information regarding each of the set members. Continuing the example, the transport resource manager 532 would select performance and other information not only for carrier 1054 and route segment 1056 but also, for purposes of comparison, for carrier 1032 and route segment 1036 as the first option and carrier 1044 and route segment 1046 as the second option.

In step 1320, the transport resource manager 532 determines key user factors for analysis, for example, timely arrival, cost, etc. These factors are user configurable.

In step 1324, the transport resource manager 532 selects and ranks the members of the set of recommended transport objects. The ranking can be based on the probable performance for the key factor. The ranking can be based on a composite value based on the relative performances of the members over multiple key user factors. Continuing with the example, a ranking could rank the first option highest, the second option next highest, and, as a third option, the carrier 1054 and route segment 1056 lowest.

In step 1328, the transport resource manager 532 provides the risk and/or recommendation(s) to the user. The recommendation can take many forms. Examples 45 include: “Take route Z and arrival time a(destination is estimated by May 1, 2017”, There is an alternative route but it may take more time than waiting at the current hub in the current route”, and the like.

The risk and/or recommendation can be for an existing shipment or potential shipment. By way of example, a shipment in transit will be passing through or approaching a hub constituting chokepoint or bottleneck. The transport resource manager 532 can redirect the shipment along an alternate route to bypass the bottleneck. In another example, a user can query the transport resource manager for a preferred route between a selected origin and destination during a specified time of year.

The risk and/or recommendation can vary weekly, monthly, seasonally, etc. Transport objects can have varying levels of performance depending on the time of the year. For example, hubs in colder regions generally slow down in the winter while those in warmer regions become busier. Weather patterns can also vary seasonally.

Examples of the processors as described herein may include, but are not limited to, at least one of Qualcomm® Snapdragon® 800 and 801, Qualcomm® Snapdragon@ 610 and 615 with 40 LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® EX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

The example systems and methods of this disclosure have been described in relation to a computer network. However, to avoid unnecessarily obscuring the present disclosure, the preceding description omits a number of known structures and devices. This omission is not to be construed as a limitation of the scopes of the claims. Specific details are set forth to provide an understanding of the present disclosure. It should however be appreciated that the present disclosure may be practiced in a variety of ways beyond the specific detail set forth herein.

Furthermore, while the example aspects, embodiments, and/or configurations illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices, such as a server, or collocated on a particular node of a distributed network, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the disclosed embodiments, configuration, and aspects.

A number of variations and modifications of the disclosure can be used. It would be possible to provide for some features of the disclosure without providing others.

For example in one alternative embodiment, the concepts of this disclosure can be applied to analyze and represent the effect of an event impacting a network generally, such as a computer network (for example, the nodes are logical or physical function components, the branches are communication pathways between the components, the event is a malfunction or virus infestation, malware infestation, denial of service attack, and the like, and the impact is an improper operation, malfunction, decreased bandwidth or processing resource constriction), telecommunications network (for example, the nodes are logical or physical function components, the branches are communication pathways between the components, the event is a malfunction or virus infestation, malware infestation, denial of service attack, and the like, and the impact is an improper operation, malfunction, decreased bandwidth or processing resource constriction), transportation network (such as railway network, road network, air carrier network, and the like, where the node is a depot, bus station, intersection, and the like, the branch is a rail, road, or air segment, the event is heavy traffic, branch damage such as from a weather event, and the impact is traffic constrictions or choke points at other parts of the network), power grid (where the node is a utility station or sub-station, the branch is an electrically conductive pathway, the event is malfunction, conductive pathway damage such as from a weather event or abnormal energy demands, and the impact is power outages), and the like. Each of these applications has nodes and branches similar to the graph database discussed above.

In another embodiment, any of the steps described in connection with FIG. 22, FIG. 23, FIG. 24 can be performed manually, including input, such as inputting event information, information describing the supply and/or logistics chain, and the like.

In another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Example hardware that can be used for the disclosed embodiments, configurations and aspects includes computers, handheld devices, telephones (for example, cellular, Internet enabled, digital, analog, hybrids, and others), and other hardware known in the art. Some of these devices include processors (for example, a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various aspects, embodiments, and/or configurations, includes components, methods, processes, systems and/or apparatus substantially as depicted and described herein, including various aspects, embodiments, configurations embodiments, sub-combinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, for example, for improving performance, achieving ease and/or reducing cost of implementation.

The foregoing discussion has been presented for purposes of illustration and description. The foregoing is not intended to limit the disclosure to the form or forms disclosed herein. In the foregoing Detailed Description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, for example, as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A computer system, comprising:
one or more processors;
a memory storing transport graph data structures that describe transport objects and relationships between transport objects in a supply chain, the transport graph data structures comprising nodes connected by branches, each node corresponding to a transport object of the transport objects in the supply chain and each branch associated with a type of relationship between two transport objects corresponding to two nodes connected by a respective branch;
a non-transitory computer-readable medium having instructions embodied thereon, the instructions executable by the one or more processors to perform:
using the one or more processors, detecting, in data stored in digital memory and representing movement of items in a supply chain, data indicating a delay in shipment of the items on a route segment transport object from an origin transport object to a destination transport object;
using the one or more processors, identifying, from the transport graph data structures, nodes corresponding to the destination transport object, and the route segment transport object corresponding to the delay in shipment;
using the one or more processors, identifying, from the transport graph data structures, an alternate transport object node that is positioned between nodes corresponding to a current or anticipated location of the shipment and the destination transport object;
providing, via a user interface presented on a display screen, a description of the delay and the alternate transport object node.

2. The system of claim 1, further comprising, using the one or more processors, detecting the data indicating the delay by determining a current location of the shipment; calculating a delayed arrival time of the shipment at the destination transport object; comparing the delayed arrival time to stored data specifying an expected arrival time of the shipment at the destination transport object.

3. The system of claim 2, wherein calculating the delayed arrival time is based upon data values specifying a current location of the shipment, a speed of movement of the shipment, and a time required by one or more other shipments in temporal proximity to a current time to traverse one or more transport objects positioned between the current location of the shipment and the destination transport object.

4. The system of claim 1, wherein the delay is detected by:
aggregating stored historical performance information for the shipment;
comparing the historical performance information to current performance requirements.

5. The system of claim 1, wherein detecting the delay further comprises determining an impact of the delay on one or more products produced by the supply chain, and determining a potential cost of the delay;
and wherein providing the description of the delay comprises providing values specifying the impact of the delay on the one or more products or the potential cost of the delay.

6. The system of claim 5, wherein the user interface contains a plurality of tiles, wherein the shipment corresponds to a first tile of the plurality of tiles and wherein one or more of an appearance, shape, location, and size of each tile of the plurality of tiles indicates the impact of the delay on the one or more products or the potential cost of the delay.

7. The system of claim 1, wherein detecting the delay comprises:
accessing, via a network, content from a network-accessible information source comprising a social network, a weather data source, a governmental entity, or law enforcement or military authority; and
determining word usage frequency of the content.

8. The system of claim 7, wherein detecting the delay further comprises:
assigning a reliability weight to each network-accessible information source; and
modifying the word usage frequency of the content according to the reliability weight of the network-accessible information source from which the content was accessed.

9. The system of claim 1, wherein detecting the delay comprises tracking data specifying a spatial location of the shipment in substantial real time by a real-time locating system, using satellite position information or terrestrial antenna information.

10. The system of claim 1, wherein the current or anticipated location of the shipment is a hub associated with a hub transport object, and wherein the alternate transport object node is identified by a node corresponding to an alternate route segment and positioned between the node corresponding to the hub transport object and the node corresponding to the destination transport object.

11. A method comprising:
storing, in a computer-accessible memory, transport graph data structures that describe transport objects and relationships between transport objects in a supply chain, the transport graph data structures comprising nodes connected by branches, each node corresponding to a transport object of the transport objects in the supply chain and each branch associated with a type of relationship between two transport objects corresponding to two nodes connected by a respective branch;
using a first computer, using the one or more processors, detecting, in data stored in digital memory and representing movement of items in a supply chain, data indicating a delay in shipment of the items on a route segment transport object from an origin transport object to a destination transport object;
using the first computer, identifying, from the transport graph data structures, nodes corresponding to the destination transport object, and the route segment transport object corresponding to the delay in shipment;
using the first computer, identifying, from the transport graph data structures, an alternate transport object node that is positioned between nodes corresponding to a current or anticipated location of the shipment and the destination transport object;
providing, via a user interface presented on a display screen, a description of the delay and the alternate transport object node.

12. The method of claim 11, wherein the delay is detected by:
determining a current location of the shipment;
calculating a delayed arrival time of the shipment at the destination transport object;
comparing the delayed arrival time to an expected arrival time of the shipment at the destination transport object.

13. The method of claim 12, wherein calculating the delayed arrival time uses a current location of the shipment, a speed of movement of the shipment, and a time required by one or more other shipments in temporal proximity to a current time to traverse one or more transport objects positioned between the current location of the shipment and the destination transport object.

14. The method of claim 11, wherein the delay is detected by:
aggregating historical performance information for the shipment;
comparing the historical performance information to current performance requirements.

15. The method of claim 11, wherein detecting the delay comprises:
determining an impact of the delay on one or more products produced by the supply chain;
determining a potential cost of the delay;
and wherein providing the description of the delay comprises:
the impact of the delay on the one or more products or the potential cost of the delay.

16. The method of claim 15, wherein the user interface contains a plurality of tiles, wherein the shipment corresponds to a first tile of the plurality of tiles and wherein one or more of an appearance, shape, location, and size of each tile of the plurality of tiles indicates the impact of the delay on the one or more products or the potential cost of the delay.

17. The method of claim 11, wherein detecting the delay comprises:
accessing, via a network, content from a network-accessible information source comprising a social network, a weather data source, a governmental entity, or law enforcement or military authority; and
determining word usage frequency of the content.

18. The method of claim 17, wherein detecting the delay further comprises:
assigning a reliability weight to each network-accessible information source; and
modifying the word usage frequency of the content according to the reliability weight of the network-accessible information source from which the content was accessed.

19. The method of claim 11, wherein detecting the delay comprises tracking a spatial location of the shipment in substantial real time by a real-time locating system, using satellite position information or terrestrial antenna information.

20. The method of claim 11, wherein the current or anticipated location of the shipment is a hub associated with a hub transport object and wherein the alternate transport object node is identified by a node corresponding to an alternate route segment and positioned between the node corresponding to the hub transport object and the node corresponding to the destination transport object.
